(19) United States
(12) Patent Application Publication
(10) Pub. No.: US 2023/0188712 A1
(43) Pub. Date: Jun. 15, 2023

(54) VIDEO PROCESSING

(71) Applicant: Telefonaktiebolaget LM Ericsson (publ), Stockholm (SE)

(72) Inventors: Kenneth ANDERSSON, GÄVLE (SE); Jack ENHORN, KISTA (SE)

(73) Assignee: Telefonaktiebolaget LM Ericsson (publ), Stockholm (SE)

(21) Appl. No.: 17/915,324

(22) PCT Filed: Mar. 30, 2021
(86) PCT No.: PCT/EP2021/058381

§ 371 Date: Sep. 28, 2022

Related U.S. Application Data
(60) Provisional application No. 63/004,130, filed on Apr. 2, 2020.

(51) Int. Cl. H04N 19/117; H04N 19/176

(52) U.S. Cl. CPC H04N 19/117; H04N 19/176

(57) ABSTRACT

A method (400) for filtering luma block edges. The method includes assigning a value to a first decision variable by performing a block edge decision process using a first set of input samples; assigning a value to a second decision variable by performing the block edge decision process using a second set of input samples; assigning a value to a third decision variable by performing the block edge decision process using a third set of input samples; and assigning a value to a fourth decision variable by performing the block edge decision process using a fourth set of input samples. The method also includes determining that a long filter condition is satisfied. The method also includes, as a result of determining that the long filter condition is satisfied, performing a filtering process for the first set of input samples, the second set of input samples, the third set of input samples and the fourth set of input samples, using a long filter to produce a first set of output samples, a second set of output samples, a third set of output samples and a fourth set of output samples. The long filter condition is satisfied if and only if: the value of the first decision variable is equal to a first value, the value of the second decision variable is equal to the first value, the value of the third decision variable is equal to the first value, and the value of the fourth decision variable is equal to the first value.

### TECHNICAL FIELD

Disclosed are embodiments related to the processing (e.g., encoding and decoding) of video data.

### BACKGROUND

A video sequence consists of a series of images (a.k.a., pictures) where each image consists of one or more components. Each component can be described as a two-dimensional rectangular array of sample values. It is common that an image in a video sequence consists of three components; one luma component Y where the sample values are luma values and two chroma components Cb and Cr, where the sample values are chroma values. Other examples include Y′ Cb Cr, Yuv and ICTCP. In ICTCP, I is the “intensity luma” component. For the remainder of this document we will refer to any luma component Y′, Y or I as Y or simply luma. It is common that the dimensions of the chroma components are smaller than the luma components by a factor of two in each dimension. For example, the size of the luma component of an HD image would be 1920×1080 and the chroma components would each have the dimension of 960×540. Components are sometimes referred to as color components.

A “block” is a two-dimensional array of samples. In video coding, each component is split into one or more blocks and the coded video bitstream is a series of blocks. It is common in video coding that an image is split into units that cover a specific area of the image. Each unit consist of all blocks from all components that make up that specific area and each block belongs fully to one unit. The macroblock in H.264 and the Coding unit (CU) in HEVC are examples of units.

In HEVC, each image is partitioned into coding tree units (CTU). A CTU consist of an N×N block of luma samples and two M×M corresponding chroma blocks. A CTU in HEVC is like macroblocks in H.264 and earlier standards but in contrast to macroblocks the CTU size is configurable. Most often, however, the CTU size in HEVC is set to 64×64 luma samples. Each CTU can be recursively quadtree split. The root of the quadtree is then associated with the CTU. The quadtree is split until a leaf is reached, which is referred to as the coding unit (CU). A CU in HEVC always consist of a luma block with equal height and width. How each CTU is split is conveyed in the bitstream. The CU is further the root node of two other trees, the prediction tree that has prediction units (PUs) as nodes and the transform tree that has transform units (TUs) as nodes. Some decoding processes in HEVC are done on the CU level, some are done on the PU level and some on TU level. Boundaries between PUs and boundaries between TUs are filtered by a deblocking filter to reduce discontinuities between TUs and PUs. In HEVC there exist two kinds of prediction types for a PU, intra-prediction which only uses prediction from previously decoded samples of the current image for prediction, and inter-prediction which uses prediction form at least one previously decoded image.

In HEVC, deblocking is first applied on vertical boundaries and then on horizontal boundaries. The boundaries are either TU boundaries or PU boundaries. To enable parallel friendly deblocking, the deblocking is performed on an 8×8 sample grid.

A deblocking filter strength parameter (bs) is set for each 4 sample part of the boundary. If the value of bs is larger than 0, then deblocking may be applied. The larger the boundary strength is, the stronger filtering is applied. First it is checked if any of the blocks at a PU boundary between the blocks is an intra predicted block then (bs is set to=2), or if both blocks use inter prediction but and they use different reference frames or have significantly different motion vectors then (bs is set to =1). It is also checked if a TU boundary between the blocks has non-zero transform coefficients in at least one of the blocks (code block flag CBF equal to 1), then (bs is set to =1). This first check sets a boundary strength (bs) which is larger than 0 to indicate that deblocking should be applied for a 4 sample part of the boundary. The larger the boundary strength is the stronger filtering is applied.

To reduce/avoid removing natural structures when deblocking, deblocking edge decisions check that there are not any natural structures on respective sides of the boundary is then applied for luma. In HEVC, gradient calculations are used on respective sides of the boundary using the following inequality: abs(p0−2*p1+p2)+abs(q0−2*q1+q2)<beta, where beta (also denoted “β”) is a parameter based on the quantization parameter for the block and p0, p1, to p2 are samples on one side of the block boundary and q0, q1, to q2 are samples on the other side of the block boundary. The condition is checked at two lines across of the 4 sample part of the boundary, line 0 and 3, and if both conditions are fulfilled, then the luma samples are deblocked for that 4 sample part of the boundary. This is applied for all 4 sample parts of a boundary until all samples of the block boundary have been checked and possibly filtered. Chroma boundaries may always be filtered if one any of the neighbouring blocks are intra coded.

In the current draft of the specification for Versatile Video Coding (VVC) (see reference [1]) (also referred to herein as the “VVC Draft Specification”) a coding tree unit (CTU) is similar to the CTU in HEVC with the difference that the CTU in H.266 has a size of 128×128 luma samples. In VVC, the CTU can be split more flexibly such that a resulting CUs may consist of a rectangular luma block. In VVC, there is no prediction tree or transform tree as in HEVC. However, a CU in VVC can be divided into a multiple of TUs or into a multiple of prediction subblocks.

In the current draft of the specification for VVC, the deblocking is applied on an 4×4 grid for CUs first on vertical boundaries (CU/implicit TU/prediction sub-block boundaries) and then on horizontal boundaries (CU/implicit TU/prediction sub-blocks). Prediction sub-block boundaries inside a CU is filtered on an 8×8 grid. The deblocking is based on HEVC deblocking but also have longer deblocking filters if the size orthogonal to the block boundary is equal to or larger than 32 on at least one side for luma and the other side is larger than 4, modifying at most 7 samples (reading at most 8 samples), if the size orthogonal to the block boundary is less than 32 for one side for luma it modifies at most 3 samples and reading at most 4 samples on that side, and if it is equal to or larger than 8 on both side of a boundary in chroma samples for chroma modifying at most 3 chroma samples and reading at most 4 chroma samples otherwise it modifies at most one sample and reading at most two samples on respective side of the boundary.

The deblocking edge decisions are computed for line 0 and line 3 for a 4 sample segment of the block boundary. Based on the deblocking edge decision either long deblocking filter, strong deblocking filter or weak deblocking filter is applied for filtering lines 0 to 3 of the for sample segment of the block boundary.

The following is an excerpt from the VVC Draft Specification. This excerpt describes a block edge decision process (more specifically, the decision process for luma block edges).

8.8.3.6.1 Decision process for luma block edges

[The] Inputs to this process are:

a picture sample array recPicture,
a location ( xCb, yCb ) specifying the top-left sample of the current coding block relative to the top-
left sample of the current picture,
a location ( xBl, yBl ) specifying the top-left sample of the current block relative to the top-left
sample of the current coding block,
a variable edgeType specifying whether a vertical (EDGE_VER) or a horizontal (EDGE_HOR) edge is
filtered,
a variable bS specifying the boundary filtering strength,
a variable maxFilterLengthP specifying the maximum filter length,
a variable maxFilterLengthQ specifying the maximum filter length.

[The] Outputs of this process are:

the variables dE, dEp and dEq containing decisions,
the modified filter length variables maxFilterLengthP and maxFilterLengthQ,
the variable t_{C}.

The sample values p_{i,k} and q_{j,k} with i = 0..Max( 2, maxFilterLengthP ), j = 0..Max( 2, maxFilterLengthQ )
and k = 0 and 3 are derived as follows:

| If edgeType is equal to EDGE_VER, the following applies: | |
|---|---|
| | q_{j,k} = recPicture[ xCb + xBl + j ][ yCb + yBl + k ] (1287) |
| | p_{i,k} = recPicture[ xCb + xBl − i − 1 ][ yCb + yBl + k ] (1288) |
| Otherwise (edgeType is equal to EDGE_HOR), the following applies: | |
| | q_{j,k} = recPicture[ xCb + xBl + k ][ yCb + yBl + j ] (1289) |
| | p_{i,k} = recPicture[ xCb + xBl + k ][ yCb + yBl − i − 1 ] (1290) |

The variable qpOffset is derived as follows:

| If sps_ladf_enabled_flag is equal to 1, the following applies: | | | | |
|---|---|---|---|---|
| | The variable lumaLevel of the reconstructed luma level is derived as follow: | | | |
| | | lumaLevel = (( p_{0,0} + p_{0,3} + q_{0,0} + q_{0,3} ) >> 2 ), (1291) | | |
| | The variable qpOffset is set equal to sps_ladf_lowest_interval_qp_offset and modified as | | | |
| | follows: | | | |
| | | for( i = 0; i < sps_num ladf_intervals_minus2 + 1; i++ ) { | | |
| | | | if( lumaLevel > SpsLadfIntervalLowerBound[ i + 1 ]) | |
| | | | | qpOffset = sps_ladf_qp_offset[ i ] (1292) |
| | | | else | |
| | | | | break |

}

Otherwise, qpOffset is set equal to 0.

The variables Qp_{Q} and Qp_{P} are set equal to the Qp_{Y} values of the coding units which include the
coding blocks containing the sample q_{0,0} and p_{0,0}, respectively.
The variable qP is derived as follows:

qP = (( Qp_{Q} + Qp_{P} + 1 ) >> 1 ) + qpOffset (1293)

The value of the variable β′ is determined as specified in Table 43 based on the quantization
parameter Q derived as follows:

Q = Clip3( 0, 63, qP + ( slice_beta_offset_div2 << 1 )) (1294)

where slice_beta_offset_div2 is the value of the syntax element slice_beta_offset_div2 for the slice
that contains sample q₀,₀.
The variable β is derived as follows:

β = β′ * (1 << ( BitDepth − 8 )) (1295)

The value of the variable t_{C}′ is determined as specified in Table 43 based on the quantization
parameter Q derived as follows:

Q = Clip3( 0, 65, qP + 2 * ( bS − 1 ) + ( slice_tc_offset_div2 << 1 )) (1296)

where slice_tc_offset_div2 is the value of the syntax element slice_tc_offset_div2 for the slice that
contains sample q₀,₀.
The variable t_{c} is derived as follows:

t_{C} = BitDepth < 10 ? ( t_{C}′ + 2 ) >> ( 10 − BitDepth ) : t_{C}′ * ( 1 << ( BitDepth − 10 )) (1297)

The following ordered steps apply:

| 1. | The variables dp0, dp3, dq0 and dq3 are derived as follows: | | | |
|---|---|---|---|---|
| | | dp0 = Abs( p_{2,0} − 2 * p_{1,0} + p_{0,0} ) (1298) | | |
| | | dp3 = Abs( p_{2,3} − 2 * p_{1,3} + p_{0,3} ) (1299) | | |
| | | dq0 = Abs( q_{2,0} − 2 * q_{1,0} + q_{0,0} ) (1300) | | |
| | | dq3 = Abs( q_{2,3} − 2 * q_{1,3} + q₀,₃ ) (1301) | | |
| 2. | When maxFilterLengthP and maxFilterLengthQ both are equal to or greater than 3 the variables | | | |
| | sp0, sq0, spq0, sp3, sq3 and spq3 are derived as follows: | | | |
| | | sp0 = Abs( p_{3,0} − p_{0,0} ) (1302) | | |
| | | sq0 = Abs( q_{0,0} − q_{3,0} ) (1303) | | |
| | | spq0 = Abs( p_{0,0} − q_{0,0} ) (1304) | | |
| | | sp3 = Abs( p_{3,3} − p_{0,3} ) (1305) | | |
| | | sq3 = Abs( q_{0,3} − q_{3,3} ) (1306) | | |
| | | spq3 = Abs( p_{0,3} − q_{0,3} ) (1307) | | |
| 3. | The variables sidePisLargeBlk and sideQisLargeBlk are set equal to 0. | | | |
| 4. | When maxFilterLengthP is greater than 3, sidePisLargeBlk is set equal to 1. | | | |
| 5. | When maxFilterLengthQ is greater than 3, sideQisLargeBlk is set equal to 1. | | | |
| 6. | When edgeType is equal to EDGE_HOR and ( yCb + yBl ) % CtbSizeY is equal to 0, sidePisLargeBlk | | | |
| | is set equal to 0. | | | |
| 7. | The variables dSam0 and dSam3 are initialized to 0. | | | |
| 8. | When sidePisLargeBlk or sideQisLargeBlk is greater than 0, the following applies: | | | |
| | a. | The variables dp0L, dp3L are derived and maxFilterLengthP is modified as follows: | | |
| | | | If sidePisLargeBlk is equal to 1, the following applies: | |
| | | | | dp0L = ( dp0 + Abs( p_{5,0} − 2 * p_{4,0} + p_{3,0} ) + 1 ) >> 1 (1308) |
| | | | | dp3L = ( dp3 + Abs( p_{5,3} − 2 * p_{4,3} + p_{3,3} ) + 1 ) >> 1 (1309) |
| | | | Otherwise, the following applies: | |
| | | | | dp0L = dp0 (1310) |
| | | | | dp3L = dp3 (1311) |
| | | | | maxFilterLengthP = 3 (1312) |
| | b. | The variables dq0L and dq3L are derived as follows: | | |
| | | | If sideQisLargeBlk is equal to 1, the following applies: | |
| | | | | dq0L = ( dq0 + Abs( q_{5,0} − 2 * q_{4,0} + q_{3,0} ) + 1 ) >> 1 (1313) |
| | | | | dq3L = ( dq3 + Abs( q_{5,3} − 2 * q_{4,3} + q_{3,3} ) + 1 ) >> 1 (1314) |
| | | | Otherwise, the following applies: | |
| | | | | dq0L = dq0 (1315) |
| | | | | dq3L = dq3 (1316) |
| | c. | The variables sp0L and sp3L are derived as follows: | | |
| | | | If maxFilterLengthP is equal to 7, the following applies: | |
| | | | | sp0L = sp0 + Abs( p_{7,0} − p_{6,0} − p_{5,0} + p_{4,0}) (1317) |
| | | | | sp3L = sp3 + Abs( p_{7,3} − p_{6,3} − p_{5,3} + p_{4,3}) (1318) |
| | | | Otherwise, the following applies: | |
| | | | | sp0L = sp0 (1319) |
| | | | | sp3L = sp3 (1320) |
| | d. | The variables sq0L and sq3L are derived as follows: | | |
| | | | If maxFilterLengthQ is equal to 7, the following applies: | |
| | | | | sq0L = sq0 + Abs( q_{4,0} − q_{5,0} − q_{6,0} + q_{7,0} ) (1321) |
| | | | | sq3L = sq3 + Abs( q_{4,3} − q_{5,3} − q_{6,3} + q_{7,3} ) (1322) |
| | | | Otherwise, the following applies: | |
| | | | | sq0L = sq0 (1323) |
| | | | | sq3L = sq3 (1324) |
| | e. | The variables dpq0L, dpq3L, and dL are derived as follows: | | |
| | | | dpq0L = dp0L + dq0L (1325) | |
| | | | dpq3L = dp3L + dq3L (1326) | |
| | | | dL = dpq0L + dpq3L (1327) | |
| | f. | When dL is less than β, the following ordered steps apply: | | |
| | | i. | The variable dpq is set equal to 2 * dpq0L. | |
| | | ii. | The variable sp is set equal to sp0L, the variable sq is set equal to sq0L and the | |
| | | | variable spq is set equal to spq0. | |
| | | iii. | The variables p₀ p₃ q₀ and q₃ are first initialized to 0 and then modified according to | |
| | | | sidePisLargeBlk and sideQisLargeBlk as follows: | |
| | | | | When sidePisLargeBlk is equal to 1, the following applies: |
| | | | | p₃ = p_{3,0} (1328) |
| | | | | p₀ = p_{maxFilterLengthP,0} (1329) |
| | | | | When sideQisLargeBlk is equal to 1, the following applies: |
| | | | | q₃ = q_{3,0} (1330) |
| | | | | q₀ = q_{maxFilterLengthQ,0} (1331) |
| | | iv. | For the sample location ( xCb + xBl, yCb + yBl ), the decision process for a luma | |
| | | | sample as specified in clause 8.8.3.6.5 is invoked with the sample values p₀, p₃, q₀, q₃, | |
| | | | the variables dpq, sp, sq, spq, sidePisLargeBlk, sideQisLargeBlk, β and t_{C} as inputs, | |
| | | | and the output is assigned to the decision dSam0. | |
| | | v. | The variable dpq is set equal to 2 * dpq3L. | |
| | | vi. | The variable sp is set equal to sp3L, the variable sq is set equal to sq3L and the | |
| | | | variable spq is set equal to spq3. | |
| | | vii. | The variables p₀ p₃ q₀ and q₃ are first initialized to 0 and are then modified according | |
| | | | to sidePisLargeBlk and sideQisLargeBlk as follows: | |
| | | | | When sidePisLargeBlk is equal to 1, the following applies: |
| | | | | p₃ = p_{3,3} (1332) |
| | | | | p₀ = p_{maxFilterLengthP,3} (1333) |
| | | | | When sideQisLargeBlk is equal to 1, the following applies: |
| | | | | q₃ = q_{3,3} (1334) |
| | | | | q₀ = q_{maxFilterLengthQ,3} (1335) |
| | | viii. | When edgeType is equal to EDGE_VER for the sample location | |
| | | | ( xCb + xBl, yCb + yBl + 3 ) or when edgeType is equal to EDGE_HOR for the sample | |
| | | | location ( xCb + xBl + 3, yCb + yBl ), the decision process for a luma sample as | |
| | | | specified in clause 8.8.3.6.5 is invoked with the sample values p₀, p₃, q₀, q₃, the | |
| | | | variables dpq, sp, sq, spq, sidePisLargeBlk, sideQisLargeBlk, β and t_{C} as inputs, and | |
| | | | the output is assigned to the decision dSam3. | |
| 9. | The variables dE, dEp and dEq are derived as follows: | | | |
| | | If dSam0 and dSam3 are both equal to 1, the variable dE is set equal to 3, dEp is set equal | | |
| | | to 1, and dEq is set equal to 1. | | |
| | | Otherwise, the following ordered steps apply: | | |
| | | a. | The variables dpq0, dpq3, dp, dq and d are derived as follows: | |
| | | | | dpq0 = dp0 + dq0 (1336) |
| | | | | dpq3 = dp3 + dq3 (1337) |
| | | | | dp = dp0 + dp3 (1338) |
| | | | | dq = dq0 + dq3 (1339) |
| | | | | d = dpq0 + dpq3 (1340) |
| | | b. | The variables dE, dEp, dEq, sidePisLargeBlk and sideQisLargeBlk are set equal to 0. | |
| | | c. | When d is less than β and both maxFilterLengthP and maxFilterLengthQ are greater | |
| | | | than 2, the following ordered steps apply: | |
| | | | i. | The variable dpq is set equal to 2 * dpq0. |
| | | | ii. | The variable sp is set equal to sp0, the variable sq is set equal to sq0 and the |
| | | | | variable spq is set equal to spq0. |
| | | | iii. | For the sample location ( xCb + xBl, yCb + yBl ), the decision process for a luma |
| | | | | sample as specified in clause 8.8.3.6.5 is invoked with the variables p₀, p₃, q₀, |
| | | | | q₃ all set equal to 0, the variables dpq, sp, sq, spq, sidePisLargeBlk, |
| | | | | sideQisLargeBlk, β and t_{C} as inputs, and the output is assigned to the decision |
| | | | | dSam0. |
| | | | iv. | The variable dpq is set equal to 2 * dpq3. |
| | | | v. | The variable sp is set equal to sp3, the variable sq is set equal to sq3 and the |
| | | | | variable spq is set equal to spq3. |
| | | | vi. | When edgeType is equal to EDGE_VER for the sample location |
| | | | | ( xCb + xBl, yCb + yBl + 3 ) or when edgeType is equal to EDGE_HOR for the |
| | | | | sample location ( xCb + xBl + 3, yCb + yBl ), the decision process for a sample as |
| | | | | specified in clause 8.8.3.6.5 is invoked with the variables p₀, p₃, q₀, q₃ all set |
| | | | | equal to 0, the variables dpq, sp, sq, spq, sidePisLargeBlk, sideQisLargeBlk, β |
| | | | | and t_{C} as inputs, and the output is assigned to the decision dSam3. |
| | | d. | When d is less than β, the following ordered steps apply: | |
| | | | i. | The variable dE is set equal to 1. |
| | | | ii. | When dSam0 is equal to 1 and dSam3 is equal to 1, the variable dE is set equal |
| | | | | to 2 and both maxFilterLengthP and maxFilterLengthQ are set equal to 3. |
| | | | iii. | When maxFilterLengthP is greater than 1, and maxFilterLengthQ is greater |
| | | | | than 1, and dp is less than ( β + ( β >> 1 )) >> 3, the variable dEp is set equal |
| | | | | to 1. |
| | | | iv. | When maxFilterLengthP is greater than 1, and maxFilterLengthQ is greater |
| | | | | than 1, and dq is less than ( β + ( β >> 1 )) >> 3, the variable dEq is set equal |
| | | | | to 1. |
| | | | v. | When dE is equal to 1, maxFilterLengthP is set equal to 1 + dEp and |
| | | | | maxFilterLengthQ is set equal to 1 + dEq. |

The following is another excerpt from the VVC Draft Specification. This excerpt describes the filtering process for luma block edges:

8.8.3.6.2 Filtering process for luma block edges

[The] Inputs to this process are:

a picture sample array recPicture,
a location ( xCb, yCb ) specifying the top-left sample of the current coding block relative to the top-
left sample of the current picture,
a location ( xBl, yBl ) specifying the top-left sample of the current block relative to the top-left
sample of the current coding block,
a variable edgeType specifying whether a vertical (EDGE_VER) or a horizontal (EDGE_HOR) edge is
filtered,
the variables dE, dEp and dEq containing decisions,
the variables maxFilterLengthP and maxFilterLengthQ containing maximum filter lengths,
the variable t_{C}.

[The] Output of this process is the modified picture sample array recPicture.
Depending on the value of edgeType, the following applies:
If edgeType is equal to EDGE_VER, the following ordered steps apply:

| 1. | The sample values p_{i,k} and q_{j,k} with i = 0..maxFilterLengthP, j = 0..maxFilterLengthQ and k = 0..3 | | |
|---|---|---|---|
| | are derived as follows: | | |
| | | q_{j,k} = recPicture[ xCb + xBl + j ][ yCb +yBl + k ] (1341) | |
| | | p_{i,k} = recPicture[ xCb + xBl − i − 1 ][ yCb + yBl + k ] (1342) | |
| 2. | When dE is not equal to 0 and dE is not equal to 3, for each sample location | | |
| | ( xCb + xBl, yCb + yBl + k ), k = 0..3, the following ordered steps apply: | | |
| | a. | The filtering process for a luma sample using short filters as specified in clause 8.8.3.6.6 is | |
| | | invoked with the variables maxFilterLengthP, maxFilterLengthQ, the sample values p_{i,k}, q_{j,k} | |
| | | with i = 0..maxFilterLengthP and j = 0..maxFilterLengthQ, the decision dE, the variables dEp | |
| | | and dEq and the variable t_{C} as inputs, and the number of filtered samples nDp and nDq | |
| | | from each side of the block boundary and the filtered sample values pᵢ′ and qⱼ′ as outputs. | |
| | b. | When nDp is greater than 0, the filtered sample values pᵢ′ with i = 0..nDp − 1 replace the | |
| | | corresponding samples inside the sample array recPicture as follows: | |
| | | | recPicture[ xCb + xBl − i − 1 ][ yCb + yBl + k ] = pᵢ′ (1343) |
| | c. | When nDq is greater than 0, the filtered sample values qⱼ′ with j = 0..nDq − 1 replace the | |
| | | corresponding samples inside the sample array recPicture as follows: | |
| | | | recPicture[ xCb + xBl + j ][ yCb + yBl + k] = qⱼ′ (1344) |
| 3. | When dE is equal to 3, for each sample location ( xCb + xBl, yCb + yBl + k ), k = 0..3, the following | | |
| | ordered steps apply: | | |
| | a. | The filtering process for a luma sample using long filters as specified in clause 8.8.3.6.7 is | |
| | | invoked with the variables maxFilterLengthP, maxFilterLengthQ, the sample values p_{i,k}, q_{j,k} | |
| | | with i = 0..maxFilterLengthP and j = 0..maxFilterLengthQ, and t_{C} as inputs and the filtered | |
| | | samples values pᵢ′ and qⱼ′ as outputs. | |
| | b. | The filtered sample values pᵢ′ with i = 0..maxFilterLengthP − 1 replace the corresponding | |
| | | samples inside the sample array recPicture as follows: | |
| | | | recPicture[ xCb + xBl − i − l ][ yCb + yBl + k ] = pᵢ′ (1345) |
| | c. | The filtered sample values qⱼ′ with j = 0..maxFilterLengthQ − 1 replace the corresponding | |
| | | samples inside the sample array recPicture as follows: | |
| | | | recPicture[ xCb + xBl + j ][ yCb + yBl + k ] = qⱼ′ (1346) |

Otherwise (edgeType is equal to EDGE_HOR), the following ordered steps apply:

| 1. | The sample values p_{i,k} and q_{j,k} with i = 0..maxFilterLengthP, j = 0..maxFilterLengthQ and k = 0..3 | | |
|---|---|---|---|
| | are derived as follows: | | |
| | | q_{j,k} = recPicture[ xCb + xBl + k ][ yCb + yBl + j ] (1347) | |
| | | p_{i,k} = recPicture[ xCb + xBl + k ][ yCb + yBl − i − 1 ] (1348) | |
| 2. | When dE is not equal to 0 and dE is not equal to 3, for each sample location | | |
| | ( xCb + xBl + k, yCb + yBl ), k = 0..3, the following ordered steps apply: | | |
| | a. | The filtering process for a luma sample using short filters as specified in clause 8.8.3.6.6 is | |
| | | invoked with the variables maxFilterLengthP, maxFilterLengthQ, the sample values p_{i,k}, q_{i,k} | |
| | | with i = 0..maxFilterLengthP and j = 0..maxFilterLengthQ, the decision dE, the variables dEp | |
| | | and dEq, and the variable t_{C} as inputs, and the number of filtered samples nDp and nDq | |
| | | from each side of the block boundary and the filtered sample values pᵢ′ and qⱼ′ as outputs. | |
| | b. | When nDp is greater than 0, the filtered sample values pᵢ′ with i = 0..nDp − 1 replace the | |
| | | corresponding samples inside the sample array recPicture as follows: | |
| | | | recPicture[ xCb + xBl + k ][ yCb + yBl − i − 1 ] = pᵢ′ (1349) |
| | c. | When nDq is greater than 0, the filtered sample values qⱼ′ with j = 0..nDq − 1 replace the | |
| | | corresponding samples inside the sample array recPicture as follows: | |
| | | | recPicture[ xCb + xBl + k ][ yCb + yBl + j ] = qⱼ′ (1350) |
| 3. | When dE is equal to 3, for each sample location ( xCb + xBl + k, yCb + yBl ), k = 0..3, the following | | |
| | ordered steps apply: | | |
| | a. | The filtering process for a luma sample using long filters as specified in clause 8.8.3.6.7 is | |
| | | invoked with the variables maxFilterLengthP, maxFilterLengthQ, the sample values p_{i,k}, q_{i,k} | |
| | | with i = 0..maxFilterLengthP and j = 0..maxFilterLengthQ, and the variable t_{C} as inputs, and | |
| | | the filtered sample values pᵢ′ and qⱼ′ as outputs. | |
| | b. | The filtered sample values pᵢ′ with i = 0..maxFilterLengthP − 1 replace the corresponding | |
| | | samples inside the sample array recPicture as follows: | |
| | | | recPicture[ xCb + xBl + k ][ yCb + yBl − i − 1 ] = pᵢ′ (1351) |
| | c. | The filtered sample values qⱼ′ with j = 0..maxFilterLengthQ − 1 replace the corresponding | |
| | | samples inside the sample array recPicture as follows: | |
| | | | recPicture[ xCb + xBl + k ][ yCb + yBl + j ] = qⱼ′ (1352) |

The following is another excerpt from the VVC Draft Specification. This excerpt describes a decision process for a luma sample:

8.8.3.6.5 Decision process for a luma sample

```
[The] Inputs to this process are:
  the sample values p₀, p₃, q₀ and q₃,
  the variables dpq, sp, sq, spq, sidePisLargeBlk, sideQisLargeBlk, β and t_{C}.
[The] Output of this process is the variable dSam containing a decision.
The variables sp and sq are modified as follows:
  When sidePisLargeBlk is equal to 1, the following applies:
```

| | |
|---|---|
| sp = ( sp + Abs( p₃ − p₀ ) + 1 ) >> 1 | (1386) |

When sideQisLargeBlk is equal to 1, the following applies:

| | |
|---|---|
| sq = ( sq + Abs( q₃ − q₀ ) + 1 ) >> 1 | (1387) |

The variables sThr1 and sThr2 are is derived as follows:
If sidePisLargeBlk is equal to 1 or sideQisLargeBlk is equal to 1, the following applies:

| | |
|---|---|
| sThr1 = 3 * β >> 5 | (1388) |
| sThr2 = β >> 4 | (1389) |

Otherwise, the following applies:

| | |
|---|---|
| sThr1 = β >> 3 | (1390) |
| sThr2 = β >> 2 | (1391) |

```
The variable dSam is specified as follows:
  If all of the following conditions are true, dSam is set equal to 1:
      dpq is less than sThr2,
      sp + sq is less than sThr1,
      spq is less than ( 5 * t_{C} + 1 ) >> 1.
  Otherwise, dSam is set equal to 0.
```

The following is another excerpt from the VVC Draft Specification. This excerpt describes a filtering process for a luma sample using short filters:

8.8.3.6.6 Filtering process for a luma sample using short filters

```
[The] Inputs to this process are:
  the variables maxFilterLengthP and maxFilterLengthQ,
  the sample values pᵢ and qⱼ with i = 0..maxFilterLengthP and j = 0..maxFilterLengthQ,
  a variable dE,
  the variables dEp and dEq containing decisions to filter samples p1 and q1, respectively,
  a variable t_{C}.
[The] Outputs of this process are:
  the number of filtered samples nDp and nDq,
  the filtered sample values pᵢ′ and qⱼ′ with i = 0..nDp − 1, j = 0..nDq − 1.
Depending on the value of dE, the following applies:
  If the variable dE is equal to 2, nDp and nDq are both set equal to 3 and the following strong filtering
  applies:
```

| | |
|---|---|
| p₀′ = Clip3( p₀ − 3 * t_{C}, p₀ + 3 * t_{C}, ( p₂ + 2 * p₁ + 2 * p₀ + 2 * q₀ + q₁ + 4 ) >> 3 ) | (1392) |
| p₁′ = Clip3( p₁ − 2 * t_{C}, p₁ + 2 * t_{C}, ( p₂ + p₁ + p₀ + q₀ + 2 ) >> 2 ) | (1393) |
| p₂′ = Clip3( p₂ − 1 * t_{C}, p₂ + 1*t_{C}, ( 2 * p₃ + 3 * p₂ + p₁ + p₀ + q₀ + 4 ) >> 3 ) | (1394) |
| q₀′ = Clip3( q₀ − 3 * t_{C}, q₀ + 3 * t_{C}, ( p₁ + 2 * p₀ + 2 * q₀ + 2 * q₁ + q₂ + 4 ) >> 3 ) | (1395) |
| q₁′ = Clip3( q₁ − 2 * t_{C}, q₁ + 2 * t_{C}, ( p₀ + q₀ + q₁ + q2 + 2 ) >> 2 ) | (1396) |
| q₂′ = Clip3( q₂ − 1 * t_{C}, q₂ + 1 * t_{C}, ( p₀ + q₀ + q₁ + 3 * q₂ + 2 * q₃ + 4 ) >> 3 ) | (1397) |

```
  Otherwise, nDp and nDq are set both equal to 0 and the following weak filtering applies:
      The following applies:
```

| | |
|---|---|
| Δ = ( 9 * ( q₀ − p₀ ) − 3 * ( q₁ − p₁ ) + 8 ) >> 4 | (1398) |

```
      When Abs(Δ) is less than t_{C} * 10, the following ordered steps apply:
        The filtered sample values p₀′ and q₀′ are specified as follows:
```

| | |
|---|---|
| Δ = Clip3( −t_{C}, t_{C}, Δ ) | (1399) |
| p₀′ = Clip1( p₀ + Δ ) | (1400) |
| q₀′ = Clip1( q₀ − Δ ) | (1401) |

```
        When dEp is equal to 1, the filtered sample value p₁′ is specified as follows:
          Δp = Clip3( −( t_{C} >> 1 ), t_{C} >> 1, ((( p₂ + p₀ + 1 ) >> 1 ) − p₁ + Δ ) >> 1 )
            (1402)
```

| | |
|---|---|
| p₁′ = Clip1( p₁ + Δp ) | (1403) |

```
        When dEq is equal to 1, the filtered sample value q₁′ is specified as follows:
          Δq = Clip3( −( t_{C} >> 1 ), t_{C} >> 1, ((( q₂ + q₀ + 1 ) >> 1 ) − q₁ − Δ ) >> 1 )
            (1404)
```

| | |
|---|---|
| q₁′ = Clip1( q₁ + Δq ) | (1405) |

nDp is set equal to dEp + 1 and nDq is set equal to dEq + 1.
When nDp is greater than 0 and pred_mode_plt_flag of the coding unit that includes the coding block
containing the sample p₀ is equal to 1, nDp is set equal to 0
When nDq is greater than 0 and pred_mode_plt_flag of the coding unit that includes the coding block
containing the sample qo is equal to 1, nDq is set equal to 0:

The following is another excerpt from the VVC Draft Specification. This excerpt describes a filtering process for a luma sample using long filters:

8.8.3.6.7 Filtering process for a luma sample using long filters

```
[The] Inputs to this process are:
  the variables maxFilterLengthP and maxFilterLengthQ,
  the sample values pᵢ and qⱼ with i = 0..maxFilterLengthP and j = 0..maxFilterLengthQ,
  a variable t_{C}.
[The] Outputs of this process are:
  the filtered sample values pᵢ′ and qⱼ′ with i = 0..maxFilterLengthP − 1, j = 0..maxFilterLengthQ − 1.
The variable refMiddle is derived as follows:
  If maxFilterLengthP is equal to maxFilterLengthQ and maxFilterLengthP is equal to 5, the following
  applies:
```

| | |
|---|---|
| refMiddle = ( p₄ + p₃ + 2* ( p₂ + p₁ + p₀ + q₀ + q₁ + q₂ ) + q₃ + q₄ + 8) >> 4 | (1406) |

```
  Otherwise, if maxFilterLengthP is equal to maxFilterLengthQ and maxFilterLengthP is not equal to
  5, the following applies:
    refMiddle = ( p₆ + p₅ + p₄ + p₃ + p₂ + p₁ + 2* ( p₀ + q₀ ) + q₁ + q₂ + q₃ + q₄ + q₅ + q₆ + 8 ) >> 4
          (1407)
  Otherwise, if one of the following conditions are true,
    maxFilterLengthQ is equal to 7 and maxFilterLengthP is equal to 5,
    maxFilterLengthQ is equal to 5 and maxFilterLengthP is equal to 7,
  the following applies:
    refMiddle = ( p₅ + p₄ + p₃ + p₂ + 2* ( p₁ + p₀ + q₀ + q₁ ) + q₂ + q₃ + q₄ + q₅ + 8 ) >> 4
          (1408)
  Otherwise, if one of the following conditions are true,
    maxFilterLengthQ is equal to 5 and maxFilterLengthP is equal to 3,
    maxFilterLengthQ is equal to 3 and maxFilterLengthP is equal to 5,
  the following applies:
    refMiddle = ( p₃ + p₂ + p₁ + p₀ + q₀ + q₁ + q₂ + q₃ + 4) >> 3 (1409)
  Otherwise, if maxFilterLengthQ is equal to 7 and maxFilterLengthP is equal to 3, the following
  applies:
    refMiddle = ( 2 * ( p₂ + p₁ + p₀ + q₀ ) + p₀ + p₁ + q₁ + q₂ + q₃ + q₄ + q₅ + q₆ + 8 ) >> 4
          (1410)
  Otherwise, the following applies:
    refMiddle = ( p₆ + p₅ + p₄ + p₃ + p₂ + p₁ + 2*( q₂ + q₁ + q₀ + p₀) + q₀ + q₁ + 8 ) >> 4
          (1411)
The variables refP and refQ are derived as follows:
```

| | |
|---|---|
| refP = ( p_{maxFilterLengtP} + P_{maxFilterLengthP-1} + 1 ) >> 1 | (1412) |
| refQ = ( q_{maxFilterLengtQ} + Q_{maxFilterLengthQ-1} + 1 ) >> 1 | (1413) |

The variables fᵢ and t_{C}PDᵢ are defined as follows:
If maxFilterLengthP is equal to 7, the following applies:

| | |
|---|---|
| f_{0..6} = { 59, 50, 41, 32, 23, 14, 5 } | (1414) |
| t_{C}PD_{0..6} = { 6, 5, 4, 3, 2, 1, 1 } | (1415) |

Otherwise, if maxFilterLengthP is equal to 5, the following applies:

| | |
|---|---|
| f_{0..4} = { 58, 45, 32, 19, 6 } | (1416) |
| t_{C}PD_{0..4} = { 6, 5, 4, 3, 2 } | (1417) |

Otherwise, the following applies:

| | |
|---|---|
| f_{0..2} = { 53, 32, 11 } | (1418) |
| t_{C}PD_{0..2} = { 6, 4, 2 } | (1419) |

The variables gⱼ and t_{C}QDⱼ are defined as follows:
If maxFilterLengthQ is equal to 7, the following applies:

| | |
|---|---|
| g_{0..6} = { 59, 50, 41, 32, 23, 14, 5 } | (1420) |
| t_{C}QD_{0..6} = ( 6, 5, 4, 3, 2, 1, 1 } | (1421) |

Otherwise, if maxFilterLengthQ is equal to 5, the following applies:

| | |
|---|---|
| g_{0..4} = { 58, 45, 32, 19, 6 } | (1422) |
| t_{C}QD_{0..4} = { 6, 5, 4, 3, 2 } | (1423) |

Otherwise, the following applies:

| | |
|---|---|
| g_{0..2} = { 53, 32, 11 } | (1424) |
| t_{C}QD_{0..2} = { 6, 4, 2 } | (1425) |

The filtered sample values pᵢ′ and qⱼ′ with i = 0..maxFilterLengthP − 1 and j = 0..maxFilterLengthQ − 1
are derived as follows:
pᵢ′ = Clip3( pᵢ − (t_{C} * t_{C}PDᵢ >> 1 ), pᵢ + ( t_{C} * t_{C}PDᵢ >> 1 ), ( refMiddle * fᵢ +

| | |
|---|---|
| refP * ( 64 − fᵢ ) + 32) >> 6 ) | (1426) |

qⱼ′ = Clip3( qⱼ − (t_{C} * t_{C}QD >> 1 ), qⱼ + ( t_{C} * t_{C}QDⱼ >> 1 ), ( refMiddle * gⱼ +

| | |
|---|---|
| refQ * (64 − gⱼ) + 32) >> 6 ) | (1427) |

When pred_mode_plt_flag of the coding unit that includes the coding block containing the sample pᵢ
is equal to 1, the filtered sample value, pᵢ′ is substituted by the corresponding input sample value pᵢ
with i = 0..maxFilterLengthP − 1.
When pred_mode_plt_flag of the coding unit that includes the coding block containing the sample qᵢ
is equal to 1, the filtered sample value, qᵢ′ is substituted by the corresponding input sample value qⱼ
with j = 0..maxFilterLengthQ − 1.

### SUMMARY

Certain challenges presently exist. For example, currently the long deblocking decision is based on checks for line 0 and 3 for each 4 samples boundary segment, which works fine in many cases, but in some corner cases, if there is some structure or details on line 1 on samples p_{0,1} to p_{7,1} and q_{0,1} to q_{7,1} or on line 2 on samples p_{0,2} to p_{7,2} and q_{0,2} to q_{7,2}, then deblocking can be applied since line 0 and line 3 pass the check which then can cause over filtering of 28 samples for a 4 sample boundary segment, e.g. p_{0,1} to p_{6,1}, q_{0,1} to q_{6,1}, p_{0,2} to p_{6,2} and q_{0,2} to q_{6,2}.

This disclosure aims to overcome this problem. For example, the problem can be overcome by checking all lines for true edges before applications of a deblocking filter that can modify more than three samples on at least one side of a block boundary. That is, this disclosure proposes to fix the long deblocking decision such that all lines of respective 4 samples boundary segment are checked to avoid over filtering of lines 1 and 2 due to decision based only on line 0 and line 3. In one embodiment, the proposal ensures that the deblocking filtering is robust and that the fix does not increase worst case complexity for deblocking decisions.

Accordingly, in one aspect there is provided a method for filtering luma block edges. The method includes assigning a value to a first decision variable by performing a block edge decision process using a first set of input samples; assigning a value to a second decision variable by performing the block edge decision process using a second set of input samples; assigning a value to a third decision variable by performing the block edge decision process using a third set of input samples; and assigning a value to a fourth decision variable by performing the block edge decision process using a fourth set of input samples. The method also includes determining that a long filter condition is satisfied. The method also includes, as a result of determining that the long filter condition is satisfied, performing a filtering process for the first set of input samples, the second set of input samples, the third set of input samples and the fourth set of input samples, using a long filter to produce a first set of output samples, a second set of output samples, a third set of output samples and a fourth set of output samples. The long filter condition is satisfied if and only if: the value of the first decision variable is equal to a first value, the value of the second decision variable is equal to the first value, the value of the third decision variable is equal to the first value, and the value of the fourth decision variable is equal to the first value.

In another aspect there is provided a computer program comprising instructions which when executed by processing circuitry of an apparatus causes the apparatus to perform the method. In another aspect there is provided a carrier containing the computer program, wherein the carrier is one of an electronic signal, an optical signal, a radio signal, and a computer readable storage medium.

In another aspect there is provided an apparatus, where the apparatus is configured to perform the method of any embodiments disclosed herein. In some embodiments, the apparatus includes processing circuitry and a memory containing instructions executable by the processing circuitry, whereby the apparatus is configured to perform the methods disclosed herein.

The embodiments disclosed herein are advantageous in that the embodiments avoid removing natural structure on half of the lines of a four sample boundary segment that currently the deblocking is unware of.

### BRIEF DESCRIPTION OF THE DRAWINGS

The accompanying drawings, which are incorporated herein and form part of the specification, illustrate various embodiments.

FIG. 1 illustrates a system according to an example embodiment.

FIG. 2 is a schematic block diagram of encoder according to an embodiment.

FIG. 3 is a schematic block diagram of encoder according to an embodiment.

FIG. 4 is a flowchart illustrating a process according to an embodiment.

FIG. 5 is a block diagram of an apparatus according to an embodiment.

### DETAILED DESCRIPTION

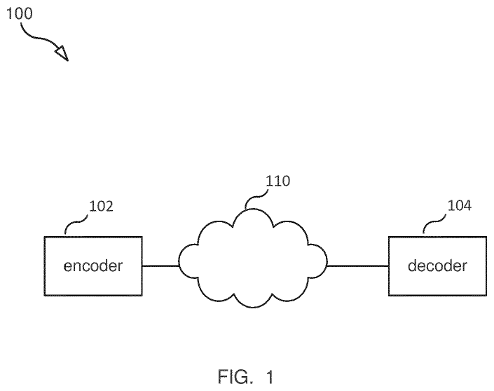

FIG. 1 illustrates a system 100 according to an example embodiment. System 100 includes an encoder 102 and a decoder 104. In the example shown, decoder 104 can receive via a network 110 (e.g., the Internet or other network) encoded images produced by encoder 102.

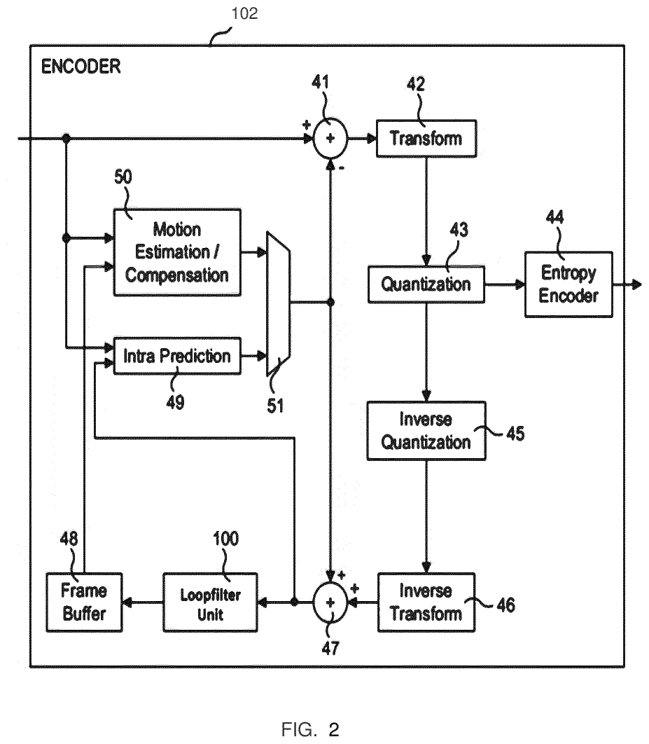

FIG. 2 is a schematic block diagram of encoder 102. As illustrated in FIG. 2, The encoder 102 takes in an original image and subtracts a prediction 41 that is selected 51 from either previously decoded samples (“Intra Prediction” 49) or samples from previously decoded frames stored in the frame buffer 48 through a method called motion compensation 50. The task of finding the best motion compensation samples is typically called motion estimation 50 and involves comparing against the original samples. After subtracting the prediction 41 the resulting difference is transformed 42 and subsequently quantized 43. The quantized results are entropy encoded 44 resulting in bits that can be stored, transmitted or further processed. The output from the quantization 43 is also inversely quantized 45 followed by an inverse transform 46. Then the prediction from 51 is added 47 and the result is forwarded to both the intra prediction unit 49 and to the Loopfilter Unit 100. The loopfilter unit 100 may do deblocking, SAO and/or ALF filtering (including CC-ALF filtering). The result is stored in the frame buffer 48, which is used for future prediction. Not shown in FIG. 2 is that coding parameters for other blocks such as 42, 43, 49, 50, 51 and 100 also may also be entropy coded.

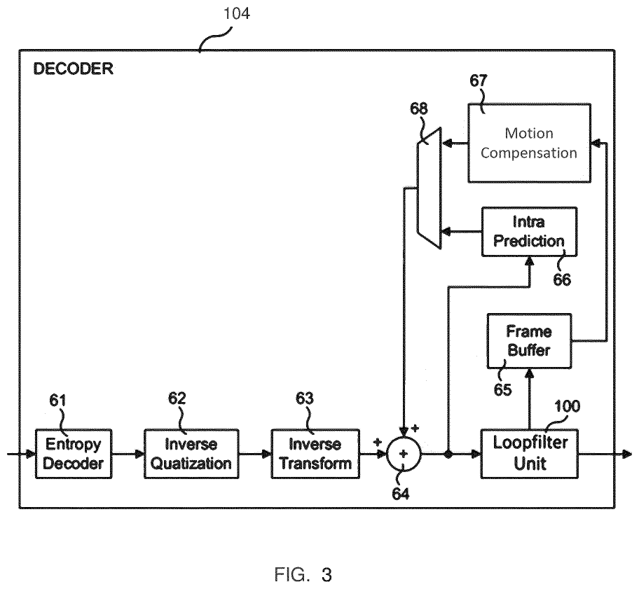

FIG. 3 is a corresponding schematic block diagram of decoder 104 according to some embodiments. The decoder 104 takes in entropy coded transform coefficients which are then decoded by decoder 61. The output of decoder 61 then undergoes inverse quantization 62 followed by inverse transform 63 to form a decoded residual. To this decoded residual, a prediction is added 64. The prediction is selected 68 from either a motion compensation unit 67 or from an intra prediction unit 66. After having added the prediction to the decoded residual 64, the samples can be forwarded for intra prediction of subsequent blocks. The samples are also forwarded to the loopfilter unit 100, which may do deblocking, SAO processing, and/or ALF processing (including CC-ALF filtering). The output of the loopfilter unit 100 is forwarded to the frame buffer 65, which can be used for motion compensation prediction of subsequently decoded images 67. The output of the loopfilter unit 100 can also be output the decoded images for viewing or subsequent processing outside the decoder. Not shown in FIG. 3 is that parameters for other blocks such as 63, 67, 66 and 100 may also be entropy decoded. As an example, the coefficients for the ALF filter in block 100 may be entropy decoded.

The embodiments disclosed herein can be used to avoid removing natural structure. This can be applied in encoder 102 and/or decoder 104.

In one embodiment additional checks for line 1 and 2 are added to the long luma deblocking decision to avoid removing structure on those lines when applying long luma deblocking. This can be performed without increasing the worst case for deblocking complexity since it is only applied when the long luma deblocking filter can be used.

In another optional embodiment additional checks for line 1 and 2 are also added for the strong deblocking decision (i.e., When d is less than β and both maxFilterLengthP and maxFilterLengthQ are greater than 2).

Accordingly, this disclosure proposes changes to section 8.8.3.6.1 (Decision process for luma block edges) of the VVC Draft Specification such that the decision process not only checks lines 0 and 3, but also checks lines 1 and 2 so that dSam1 and dSam2 are obtained in addition to dSam0 and dSam3 and then to require dSam0 to dSam3 to all be equal to 1 to set dE to 3, e.g. apply long luma deblocking filter in section 8.8.3.6.7. The below table includes a proposed new section 8.8.3.6.1 to replace the current section 8.8.3.6.1. The below proposed changes with respect to the strong deblocking decision (i.e., g. When d is less than β and both maxFilterLengthP and maxFilterLengthQ are greater than 2) are less preferred than the changes with respect to the long filter and thus are optional.

New 8.8.3.6.1 Decision process for luma block edges

Inputs to this process are:

a picture sample array recPicture,
a location ( xCb, yCb ) specifying the top-left sample of the current coding block relative to the top-
left sample of the current picture,
a location ( xBl, yBl ) specifying the top-left sample of the current block relative to the top-left
sample of the current coding block,
a variable edgeType specifying whether a vertical (EDGE_VER) or a horizontal (EDGE_HOR) edge is
filtered,
a variable bS specifying the boundary filtering strength,
a variable maxFilterLengthP specifying the maximum filter length,
a variable maxFilterLengthQ specifying the maximum filter length.

Outputs of this process are:

the variables dE, dEp and dEq containing decisions,
the modified filter length variables maxFilterLengthP and maxFilterLengthQ,
the variable t_{C}.

The sample values p_{i,k} and q_{j,k} with i = 0..Max( 2, maxFilterLengthP ), j = 0..Max( 2, maxFilterLengthQ )
and k = 0 and 3 are derived as follows:

| If edgeType is equal to EDGE_VER, the following applies: | |
|---|---|
| | q_{j,k} = recPicture[ xCb + xBl + j ][ yCb + yBl + k ] (1287) |
| | p_{i,k} = recPicture[ xCb + xBl − i − 1 ] [ yCb + yBl + k ] (1288) |
| Otherwise (edgeType is equal to EDGE_HOR), the following applies: | |
| | q_{i,k} = recPicture[ xCb + xBl + k ][ yCb + yBl + j ] (1289) |
| | p_{i,k} = recPicture[ xCb + xBl + k ] [ yCb + yBl − i − 1 ] (1290) |

The variable qpOffset is derived as follows:

| If sps_ladf_enabled_flag is equal to 1, the following applies: | | | | |
|---|---|---|---|---|
| | The variable lumaLevel of the reconstructed luma level is derived as follow: | | | |
| | | lumaLevel = (( p_{0,0} + p_{0,3} + q_{0,0} + q_{0,3} ) >> 2 ), (1291) | | |
| | The variable qpOffset is set equal to sps_ladf_lowest_interval_qp_offset and modified as | | | |
| | follows: | | | |
| | | for( i = 0; i < sps_num_ladf_intervals_minus2 + 1; i++ ) { | | |
| | | | if( lumaLevel > SpsLadfIntervalLowerBound[ i + 1 ] ) | |
| | | | | qpOffset = sps_ladf_qp_offset[ i ] (1292) |
| | | | else | |
| | | | | break |

}

Otherwise, qpOffset is set equal to 0.

The variables Qp_{Q} and Qp_{P} are set equal to the Qp_{Y} values of the coding units which include the
coding blocks containing the sample q_{0,0} and p_{0,0}, respectively.
The variable qP is derived as follows:

qP = (( Qp_{Q} + Qp_{P} + 1 ) >> 1 ) + qpOffset (1293)

The value of the variable β′ is determined as specified in Table 43 based on the quantization
parameter Q derived as follows:

Q = Clip3( 0, 63, qP + ( slice_beta_offset_div2 << 1 )) (1294)

where slice_beta_offset_div2 is the value of the syntax element slice_beta_offset_div2 for the slice
that contains sample q_{0,0}.
The variable β is derived as follows:

β = β′ * ( 1 << ( BitDepth − 8 )) (1295)

The value of the variable t_{C}′ is determined as specified in Table 43 based on the quantization
parameter Q derived as follows:

Q = Clip3( 0, 65, qP + 2 * ( bS − 1 ) + ( slice_tc_offset_div2 << 1 )) (1296)

where slice_tc_offset_div2 is the value of the syntax element slice_tc_offset_div2 for the slice that
contains sample q_{0,0}.
The variable t_{C} is derived as follows:

t_{C} = BitDepth < 10 ? ( t_{C}′ + 2 ) >> ( 10 − BitDepth ) : t_{C}′ * ( 1 << ( BitDepth − 10 )) (1297)

The following ordered steps apply:

| 1. | The variables dp0, dp1, dp2, dp3, dq0, dq1, dq2 and dq3 are derived as follows: | | | |
|---|---|---|---|---|
| | | dp0 = Abs( p_{2,0} − 2 * p_{1,0} + p_{0,0} ) (1298) | | |
| | | dp1 = Abs( p_{2,1} − 2 * p_{1,1} + p_{0,1} ) (1298) | | |
| | | dp2 = Abs( p_{2,2} − 2 * p_{1,2} + p_{0,2} ) (1298) | | |
| | | dp3 = Abs( p_{2,3} − 2 * p_{1,3} + p_{0,3} ) (1299) | | |
| | | dq0 = Abs( q_{2,0} − 2 * q_{1,0} + q_{0,0} ) (1300) | | |
| | | dq1 = Abs( q_{2,1} − 2 * q_{1,1} + q_{0,1} ) (1300) | | |
| | | dq2 = Abs( q_{2,2} − 2 * q_{1,2} + q₀,₂ ) (1300) | | |
| | | dq3 = Abs( q₂,₃ − 2 * q_{1,3} + q_{0,3} ) (1301) | | |
| 2. | When maxFilterLengthP and maxFilterLengthQ. both are equal to or greater than 3 the | | | |
| variables sp0, sq0, spq0, sp1, sq1, spq1, sp2, sq2, spq2, sp3, sq3 and spq3 are derived as follows: | | | | |
| | | sp0 = Abs( p_{3,0} − p_{0,0} ) (1302) | | |
| | | sq0 = Abs( q_{0,0} − q_{3,0} ) (1303) | | |
| | | spq0 = Abs( p_{0,0} − q_{0,0} ) (1304) | | |
| | | sp1 = Abs( p_{3,1} − p_{0,1} ) (1302) | | |
| | | sq1 = Abs( q_{0,1} − q_{3,1} ) (1303) | | |
| | | spq1 = Abs( p_{0,1} − q_{0,1} ) (1304) | | |
| | | sp2 = Abs( p_{3,0} − p_{0,0} ) (1302) | | |
| | | sq2 = Abs( q_{0,2} − q_{3,2} ) (1303) | | |
| | | spq2 = Abs( p_{0,2} − q_{0,2} ) (1304) | | |
| | | sp3 = Abs( p_{3,3} − p_{0,3} ) (1305) | | |
| | | sq3 = Abs( q_{0,3} − q_{3,3} ) (1306) | | |
| | | spq3 = Abs( p_{0,3} − q_{0,3} ) (1307) | | |
| 3. | The variables sidePisLargeBlk and sideQisLargeBlk are set equal to 0. | | | |
| 4. | When maxFilterLengthP is greater than 3, sidePisLargeBlk is set equal to 1. | | | |
| 5. | When maxFilterLengthQ is greater than 3, sideQisLargeBlk is set equal to 1. | | | |
| 6. | When edgeType is equal to EDGE_HOR and (yCb + yBl ) % CtbSizeY is equal to 0, | | | |
| sidePisLargeBlk is set equal to 0. | | | | |
| 7. | The variables dSam0 and dSam3 are initialized to 0 and the variables dSam1 and dSam 2 are | | | |
| initialized to 0. | | | | |
| 8. | When sidePisLargeBlk or sideQisLargeBlk is greater than 0, the following applies: | | | |
| | a. | The variables dp0L, dp1L, dp2L, dp3L are derived and maxFilterLengthP is modified as | | |
| | follows: | | | |
| | | | If sidePisLargeBlk is equal to 1, the following applies: | |
| | | | | dp0L = ( dp0 + Abs( p_{5,0} − 2 * p_{4,0} + p_{3,0} ) + 1 ) >> 1 (1308) |
| | | | | dp1L = ( dp1 + Abs( p_{5,1} − 2 * p_{4,1} + p_{3,1} ) + 1 ) >> 1 (1308) |
| | | | | dp2L = ( dp2 + Abs( p_{5,2} − 2 * p_{4,2} + p_{3,2} ) + 1 ) >> 1 (1308) |
| | | | | dp3L = ( dp3 + Abs( p_{5,3} − 2 * p_{4,3} + p_{3,3} ) + 1 ) >> 1 (1309) |
| | | | Otherwise, the following applies: | |
| | | | | dp0L = dp0 (1310) |
| | | | | dp1L = dp1 (1310) |
| | | | | dp2L = dp2 (1310) |
| | | | | dp3L = dp3 (1311) |
| | | | maxFilterLengthP = 3 (1312) | |
| | b. | The variables dq0L, dq1L, dq2L and dq3L are derived as follows: | | |
| | | | If sideQisLargeBlk is equal to 1, the following applies: | |
| | | | | dq0L = (dq0 + Abs( q_{5,0} − 2 * q_{4,0} + q_{3,0} ) + 1 ) >> 1 (1313) |
| | | | | dq1L = (dq1 + Abs( q_{5,1} − 2 * q_{4,1} + q_{3,1} ) + 1 ) >> 1 (1313) |
| | | | | dq2L = (dq2 + Abs( q_{5,2} − 2 * q_{4,2} + q_{3,2} ) + 1 ) >> 1 (1313) |
| | | | | dq3L = (dq3 + Abs( q_{5,3} − 2 * q_{4,3} + q_{3,3} ) + 1 ) >> 1 (1314) |
| | | | Otherwise, the following applies: | |
| | | | | dq0L = dq0 (1315) |
| | | | | dq1L = dq1 (1315) |
| | | | | dq2L = dq2 (1315) |
| | | | | dq3L = dq3 (1316) |
| | c. | The variables sp0L, sp1L, sp2L and sp3L are derived as follows: | | |
| | | | If maxFilterLengthP is equal to 7, the following applies: | |
| | | | | sp0L = sp0 + Abs( p_{7,0} − p_{6,0} − p_{5,0} + p_{4,0}) (1317) |
| | | | | sp1L = sp1 + Abs( p_{7,1} − p_{6,1} − p_{5,1} + p_{4,1}) (1317) |
| | | | | sp2L = sp2 + Abs( p_{7,2} − p_{6,2} − p_{5,2} + p_{4,2}) (1317) |
| | | | | sp3L = sp3 + Abs( p_{7,3} − p_{6,3} − p_{5,3} + p_{4,3}) (1318) |
| | | | Otherwise, the following applies: | |
| | | | | sp0L = sp0 (1319) |
| | | | | sp1L = sp1 (1319) |
| | | | | sp2L = sp2 (1319) |
| | | | | sp3L = sp3 (1320) |
| | d. | The variables sq0L, sq1L, sq2L, and sq3L are derived as follows: | | |
| | | | If maxFilterLengthQ is equal to 7, the following applies: | |
| | | | | sq0L = sq0 + Abs( q_{4,0} − q_{5,0} − q_{6,0} + q_{7,0} ) (1321) |
| | | | | sq1L = sq1 + Abs( q_{4,1} − q_{5,1} − q_{6,1} + q_{7,1} ) (1321) |
| | | | | sq2L = sq2 + Abs( q_{4,2} − q_{5,2} − q_{6,2} + q_{7,2} ) (1321) |
| | | | | sq3L = sq3 + Abs( q_{4,3} − q_{5,3} − q_{6,3} + q_{7,3} ) (1322) |
| | | | Otherwise, the following applies: | |
| | | | | sq0L = sq0 (1323) |
| | | | | sq1L = sq1 (1323) |
| | | | | sq2L = sq2 (1323) |
| | | | | sq3L = sq3 (1324) |
| | e. | The variables dpq0L, dpq1L, dpq2L, dpq3L, and dL are derived as follows: | | |
| | | dpq0L = dp0L + dq0L (1325) | | |
| | | dpq1L = dp1L + dq1L (1325) | | |
| | | dpq2L = dp2L + dq2L (1325) | | |
| | | dpq3L = dp3L + dq3L (1326) | | |
| | | dL = dpq0L + dpq3L (1327) | | |
| | f. | When dL is less than β, the following ordered steps apply: | | |
| | | i. | The variable dpq is set equal to 2 * dpq0L. | |
| | | ii. | The variable sp is set equal to sp0L, the variable sq is set equal to sq0L and the | |
| | | variable spq is set equal to spq0. | | |
| | | iii. | The variables p₀ p₃ q₀ and q₃ are first initialized to 0 and then modified according | |
| | | to sidePisLargeBlk and sideQisLargeBlk as follows: | | |
| | | | | When sidePisLargeBlk is equal to 1, the following applies: |
| | | | | p₃ = p_{3,0} (1328) |
| | | | | p₀ = p_{maxFilterLengthP,0} (1329) |
| | | | | When sideQisLargeBlk is equal to 1, the following applies: |
| | | | | q₃ = q_{3,0} (1330) |
| | | | | q₀ = q_{maxFilterLengthQ,0} (1331) |
| | | iv. | For the sample location ( xCb + xBl, yCb + yBl ), the decision process for a luma | |
| | | sample as specified in clause 8.8.3.6.5 is invoked with the sample values p₀, p₃, q₀, q₃ | | |
| | | the variables dpq, sp, sq, spq, sidePisLargeBlk, sideQisLargeBlk, β and t_{C} as inputs, | | |
| | | and the output is assigned to the decision dSam0. | | |
| | | v. | The variable dpq is set equal to 2 * dpq1L. | |
| | | vi. | The variable sp is set equal to sp1L, the variable sq is set equal to sq1L and the | |
| | | variable spq is set equal to spq1. | | |
| | | vii. | The variables p₀ p₃ q₀ and q₃ are first initialized to 0 and then modified according | |
| | | to sidePisLargeBlk and sideQisLargeBlk as follows: | | |
| | | | | When sidePisLargeBlk is equal to 1, the following applies: |
| | | | | p₃ = p_{3,1} (1328.1) |
| | | | | p₀ = p_{maxFilterLengthP,1} (1329.1) |
| | | | | When sideQisLargeBlk is equal to 1, the following applies: |
| | | | | q₃ = q_{3,1} (1330.1) |
| | | | | q₀ = q_{maxFilterLengthQ,1} (1331.1) |
| | | viii. | When edgeType is equal to EDGE_VER for the sample location | |
| | | ( xCb + xBl, yCb + yBl + 1 ) or when edgeType is equal to EDGE_HOR for the sample | | |
| | | location ( xCb + xBl + 1, yCb + yBl ), the decision process for a luma sample as | | |
| | | specified in clause 8.8.3.6.5 is invoked with the sample values p₀, p₃, q₀, q₃ the | | |
| | | variables dpq, sp, sq, spq, sidePisLargeBlk, sideQisLargeBlk, β and t_{C} as inputs, and | | |
| | | the output is assigned to the decision dSam1. | | |
| | | ix. | The variable dpq is set equal to 2 * dpq2L. | |
| | | x. | The variable sp is set equal to sp2L, the variable sq is set equal to sq2L and the | |
| | | | variable spq is set equal to spq2. | |
| | | xi. | The variables p₀ p₃ q₀ and q₃ are first initialized to 0 and are then modified according | |
| | | | to sidePisLargeBlk and sideQisLargeBlk as follows: | |
| | | | - | When sidePisLargeBlk is equal to 1, the following applies: |
| | | | | p₃ = p_{3,2} (1332) |
| | | | | p₀ = p_{maxFilterLengthP,2} (1333) |
| | | | - | When sideQisLargeBlk is equal to 1, the following applies: |
| | | | | q₃ = q_{3,2} (1334) |
| | | | | q₀ = q_{maxFilterLengthQ,2} (1335) |

| | | xii. | When edgeType is equal to EDGE_VER for the sample location |
|---|---|---|---|
| | | | ( xCb + xBl, yCb + yBl + 2 ) or when edgeType is equal to EDGE_HOR for the sample |
| | | | location ( xCb + xBl + 2, yCb + yBl ), the decision process for a luma sample as |
| | | | specified in clause 8.8.3.6.5 is invoked with the sample values p₀, p₃, q₀, q₃, the |
| | | | variables dpq, sp, sq, spq, sidePisLargeBlk, sideQisLargeBlk, 3 and to as inputs, and |
| | | | the output is assigned to the decision dSam2. |
| | | xiii. | The variable dpq is set equal to 2 * dpq3L. |
| | | xiv. | The variable sp is set equal to sp3L, the variable sq is set equal to sq3L and the |
| | | | variable spq is set equal to spq3. |
| | | xv. | The variables p₀ p₃ q₀ and q₃ are first initialized to 0 and are then modified according |
| | | | to sidePisLargeBlk and sideQisLargeBlk as follows: |
| | | | When sidePisLargeBlk is equal to 1, the following applies: |
| | | | p₃ = p_{3,3} (1332) |
| | | | p₀ = p_{maxFilterLengthP,3} (1333) |
| | | | When sideQisLargeBlk is equal to 1, the following applies: |
| | | | q₃ = q_{3,3} (1334) |
| | | | q₀ = q_{maxFilterLengthQ,3} (1335) |
| | | xvi. | When edgeType is equal to EDGE_VER for the sample location |
| | | | ( xCb + xBl, yCb + yBl + 3 ) or when edgeType is equal to EDGE_HOR for the sample |
| | | | location ( xCb + xBl + 3, yCb + yBl ), the decision process for a luma sample as |
| | | | specified in clause 8.8.3.6.5 is invoked with the sample values p₀, p₃, q₀, q₃ the |
| | | | variables dpq, sp, sq, spq, sidePisLargeBlk, sideQisLargeBlk, 3 and to as inputs, and |
| | | | the output is assigned to the decision dSam3. |
| 9. | The variables dE, dEp and dEq are derived as follows: | | |
| | If dSam0, dSam1, dSam2, and dSam3 are all equal to 1, the variable dE is set equal to 3, dEp | | |
| | is set equal to 1, and dEq is set equal to 1. | | |
| | Otherwise, the following ordered steps apply: | | |
| | a. | The variables dpq0, dpq3, dp, dq and d are derived as follows: | |
| | | dpq0 = dp0 + dq0 (1336) | |
| | | dpq3 = dp3 + dq3 (1337) | |
| | | dp = dp0 + dp3 (1338) | |
| | | dq = dq0 + dq3 (1339) | |
| | | d = dpq0 + dpq3 (1340) | |
| | b. | The variables dE, dEp, dEq, sidePisLargeBlk and sideQisLargeBlk are set equal to 0. | |
| | c. | When d is less than 3 and both maxFilterLengthP and maxFilterLengthQare greater | |
| | | than 2, the following ordered steps apply: | |
| | | i. | The variable dpq is set equal to 2 * dpq0. |
| | | ii. | The variable sp is set equal to sp0, the variable sq is set equal to sq0 and the |
| | | | variable spq is set equal to spq0. |
| | | iii. | For the sample location ( xCb + xBl, yCb + yBl ), the decision process for a luma |
| | | | sample as specified in clause 8.8.3.6.5 is invoked with the variables p₀, p₃, q₀, |
| | | | q₃ all set equal to 0, the variables dpq, sp, sq, spq, sidePisLargeBlk, |
| | | | sideQisLargeBlk, β and t_{C} as inputs, and the output is assigned to the decision |
| | | | dSam0. |
| | | iv. | The variable dpq is set equal to 2 * dpq1. |
| | | v. | The variable sp is set equal to sp1, the variable sq is set equal to sq1 and the |
| | | | variable spq is set equal to spq1. |
| | | vi. | For the sample location ( xCb + xBl, yCb + yBl ), the decision process for a luma |
| | | | sample as specified in clause 8.8.3.6.5 is invoked with the variables p₀, p₃, q₀, |
| | | | q₃ all set equal to 0, the variables dpq, sp, sq, spq, sidePisLargeBlk, |
| | | | sideQisLargeBlk, β and t_{C} as inputs, and the output is assigned to the decision |
| | | | dSam1. |
| | | vii. | The variable dpq is set equal to 2 * dpq2. |
| | | viii. | The variable sp is set equal to sp2, the variable sq is set equal to sq2 and the |
| | | | variable spq is set equal to spq2. |
| | | ix. | When edgeType is equal to EDGE_VER for the sample location |
| | | | ( xCb + xBl, yCb + yBl + 3 ) or when edgeType is equal to EDGE_HOR for the |
| | | | sample location ( xCb + xBl + 3, yCb + yBl ), the decision process for a sample as |
| | | | specified in clause 8.8.3.6.5 is invoked with the variables p₀, p₃, q₀, q₃ all set |
| | | | equal to 0, the variables dpq, sp, sq, spq, sidePisLargeBlk, sideQisLargeBlk, β |
| | | | and t_{C} as inputs, and the output is assigned to the decision dSam2. |
| | | x. | The variable dpq is set equal to 2 * dpq3. |
| | | xi. | The variable sp is set equal to sp3, the variable sq is set equal to sq3 and the |
| | | | variable spq is set equal to spq3. |
| | | xii. | When edgeType is equal to EDGE_VER for the sample location |
| | | | ( xCb + xBl, yCb + yBl + 3 ) or when edgeType is equal to EDGE_HOR for the |
| | | | sample location ( xCb + xBl + 3, yCb + yBl ), the decision process for a sample as |
| | | | specified in clause 8.8.3.6.5 is invoked with the variables p₀, p₃, q₀, q₃ all set |
| | | | equal to 0, the variables dpq, sp, sq, spq, sidePisLargeBlk, sideQisLargeBlk, β |
| | | | and t_{C} as inputs, and the output is assigned to the decision dSam3. |
| | d. | When d is less than β, the following ordered steps apply: | |
| | | i. | The variable dE is set equal to 1. |
| | | ii. | When dSam0 is equal to 1 and dSam3 is equal to 1 and dSam1 is equal to 1 and |
| | | | dSam2 is equal to 1, the variable dE is set equal to 2 and both maxFilterLengthP |
| | | | and maxFilterLengthQ are set equal to 3 |
| | | iii. | When maxFilterLengthP is greater than 1, and maxFilterLengthQ is greater than |
| | | | 1, and dp is less than ( β + ( β >> 1 )) >> 3, the variable dEp is set equal to 1. |
| | | iv. | When maxFilterLengthP is greater than 1, and maxFilterLengthQ is greater than |
| | | | 1, and dq is less than ( β + ( β >> 1 )) >> 3, the variable dEq is set equal to 1. |
| | | v. | When dE is equal to 1, maxFilterLengthP is set equal to 1 + dEp and |
| | | | maxFilterLengthQ is set equal to 1 + dEq. |

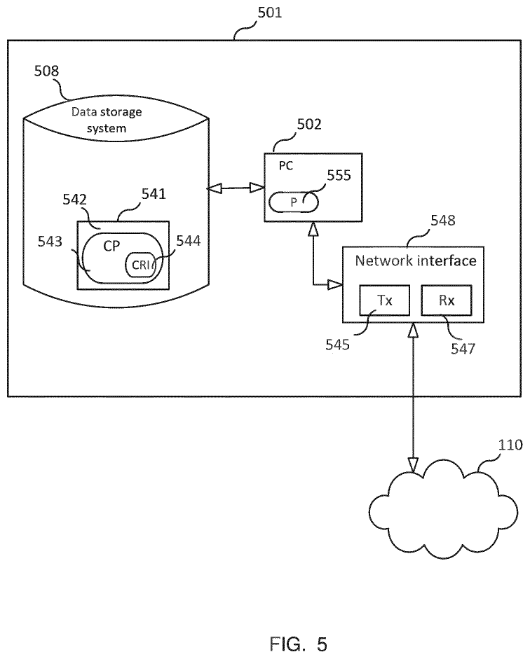

FIG. 5 is a block diagram of an apparatus 501 for implementing encoder 102 or decoder 104, according to some embodiments. That is, apparatus 501 can be adapted to perform the methods disclosed herein. In embodiments where apparatus 501 implements encoder 102, apparatus 501 may be referred to as “encoding apparatus 501,” and in embodiments where apparatus 501 implements decoder 104, apparatus 501 may be referred to as a “decoding apparatus 501.” As shown in FIG. 5, apparatus 501 comprises: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed; one or more network interfaces 548 (which may be co-located or geographically distributed) where each network interface includes a transmitter (Tx) 545 and a receiver (Rx) 547 for enabling apparatus 501 to transmit data to and receive data from other nodes connected to network 110 (e.g., an Internet Protocol (IP) network) to which network interface 548 is connected; and one or more storage units (a.k.a., “data storage systems”) 508 which may be co-located or geographically distributed and which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is adapted such that when executed by PC 502, the CRI causes apparatus 501 to perform steps described herein (e.g., steps described herein with reference to the flow charts). In other embodiments, apparatus 501 may be adapted to perform steps described herein without the need for code. That is, for example, PC 502 may consist merely of one or more ASICs. Hence, the features of the embodiments described herein may be implemented in hardware and/or software.

### SUMMARY OF THE ABOVE EMBODIMENTS

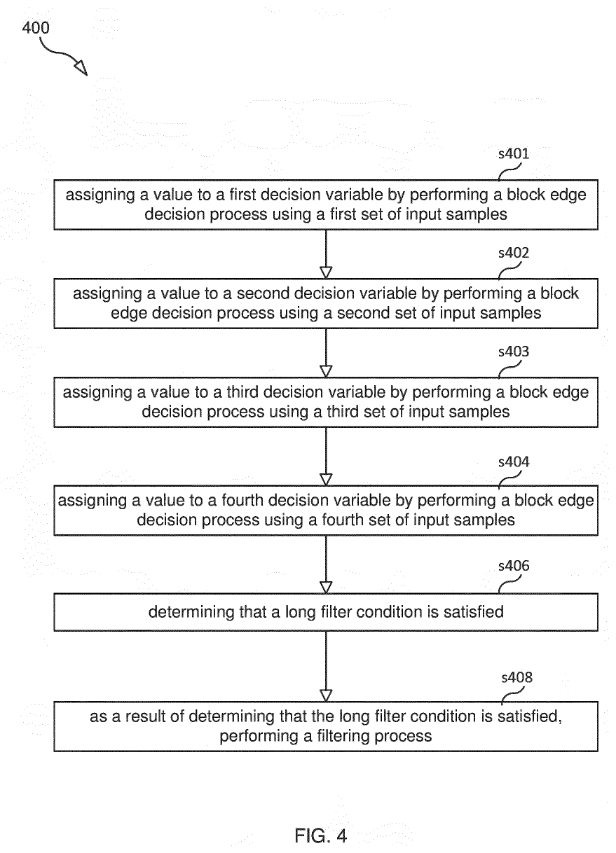

A1. A method (400, see FIG. 4) for filtering luma block edges, the method comprising: determining (s406) that a long filter condition is satisfied; and as a result of determining that the long filter condition is satisfied, performing (s408) a filtering process for a first set of input samples, a second set of input samples, a third set of input samples and a fourth set of input samples, using a long filter to produce a first set of output samples, a second set of output samples, a third set of output samples and a fourth set of output samples, wherein the long filter condition is satisfied if and only if: the value of a first decision variable is equal to a first value (e.g., 1), the value of a second decision variable is equal to the first value, the value of a third decision variable is equal to the first value, and the value of a fourth decision variable is equal to the first value.

A2. The method (400) of embodiment A1, further comprising, prior to determining that the long filter condition is satisfied: assigning (s401) a value to the first decision variable by performing a block edge decision process using the first set of input samples; assigning (s402) a value to the second decision variable by performing the block edge decision process using the second set of input samples; assigning (s403) a value to the third decision variable by performing the block edge decision process using the third set of input samples; and assigning (s404) a value to the fourth decision variable by performing the block edge decision process using the fourth set of input samples.

A3. The method of embodiment A1 or A2, wherein determining that a long filter condition is satisfied consists of determining that the value of a fifth decision variable is equal to 3.

A4. The method of embodiment A3, further comprising setting the value of the fifth decision variable to 3 as a result of determining that: i) the value of the first decision variable is equal to the first value, ii) the value of the second decision variable is equal to the first value, iii) the value of the third decision variable is equal to the first value, and iv) the value of the fourth decision variable is equal to the first value.

A5. The method of any one of embodiments A1-A4, wherein the first set of inputs are from a first line across a block boundary including samples p_{0,0}, p_{1,0}, p_{2,0}, p_{3,0}, p_{4,0}, p_{5,0}, p_{6,0}, p_{7,0} on one side of the boundary and q_{0,0}, q_{1,0}, q_{2,0}, q_{3,0}, q_{4,0}, q_{5,0}, q_{6,0}, q_{7,0} on the other side of the boundary, the second set of inputs are from a second line across the block boundary including samples p_{0,1}, p_{1,1}, p_{2,1}, p_{3,1}, p_{4,1}, p_{5,1}, p_{6,1}, p_{7,1} and q_{0,1}, q_{1,1}, q_{2,1}, q_{3,1}, q_{4,1}, q_{5,1}, q_{6,1}, q_{7,1} on the other side of the boundary, the third set of inputs are from a third line across the block boundary including samples p_{0,2}, p_{1,2}, p_{2,2}, p_{3,2}, p_{4,2}, p_{5,2}, p_{6,2}, p_{7,2} and q_{0,2}, q_{1,2}, q_{2,2}, q_{3,2}, q_{4,2}, q_{5,2}, q_{6,2}, q_{7,2} on the other side of the boundary, and the fourth set of inputs are from a fourth line across the block boundary including samples p_{0,3}, p_{1,3}, p_{2,3}, p_{3,3}, p_{4,3}, p_{5,3}, p_{6,3}, p_{7,3} and q_{,3}, q_{1,3}, q_{2,3}, q_{3,3}, q_{4,3}, q_{5,3}, q_{6,3}, q_{7,3} on the other side of the boundary.

A6. The method of any one of embodiments A1-A5, wherein the first set of output samples p′_{0,0}, p′_{1,0}, p′_{2,0}, p′_{3,0}, p′_{4,0}, p′_{5,0}, p′_{6,0}, q′_{0,0}, q′_{1,0}, q′_{2,0}, q′_{3,0}, q′_{4,0}, q′_{5,0}, q′_{6,0}, are derived from the first set of input samples, the second set of output samples p′_{0,1}, p′_{2,1}, p′_{3,1}, p′_{4,1}, p′_{5,1}, p′_{6,1}, q′_{0,1}, q′_{2,1}, q′_{3,1}, q′_{4,1}, q′_{5,1}, q′_{6,1}, are derived from the second set of input samples, the third set of output samples p′_{0,2}, p′_{1,2}, p′_{2,2}, p′_{3,2}, p′_{4,2}, p′_{5,2}, p′_{6,2}, q′_{0,2}, q′_{1,2}, q′_{2,2}, q′_{3,2}, q′_{4,2}, q′_{5,2}, q′_{6,2}, are derived from the third set of input samples, and the fourth set of output samples, p′_{0,3}, p′_{1,3}, p′_{2,3}, p′_{3,3}, p′_{4,3}, p′_{5,3}, p′_{6,3}, q′_{0,3}, q′_{1,3}, q′_{2,3}, q′_{3,3}, q′_{4,3}, q′_{5,3}, q′_{6,3} are derived from the fourth set of input samples.

A7. The method of any one of embodiments A1-A6, wherein the first set of inputs are from a first line across the block boundary including samples p_{0,0}, p_{1,0}, p_{2,0}, p_{3,0}, p_{4,0}, p_{5,0} on one side of the boundary and q_{0,0}, q_{1,0}, q_{2,0}, q_{3,0}, q_{4,0}, q_{5,0} on the other side of the boundary, the second set of inputs are from a second line across the block boundary including samples p_{0,1}, p_{1,1}, p_{2,1}, p_{3,1}, p_{4,1}, p_{5,1} and q_{0,1}, q_{1,1}, q_{2,1}, q_{3,1}, q_{4,1}, q_{5,1} on the other side of the boundary, the third set of inputs are from a third line across the block boundary including samples p_{0,2}, p_{1,2}, p_{2,2}, p_{3,2}, p_{4,2}, p_{5,2} and q_{0,2}, q_{1,2}, q_{2,2}, q_{3,2}, q_{4,2}, q_{5,2} on the other side of the boundary, and the fourth set of inputs are from a fourth line across the block boundary including samples p_{0,3}, p_{1,3}, p_{2,3}, p_{3,3}, p_{4,3}, p_{5,3} and q_{0,3}, q_{1,3}, q_{2,3}, q_{3,3}, q_{4,3}, q_{5,3} on the other side of the boundary, the first set of output samples p′_{0,0}, p′_{1,0}, p′_{2,0}, p′_{3,0}, p′_{4,0}, q′_{0,0}, q′_{1,0}, q′_{2,0}, q′_{3,0}, q′_{4,0}, are derived from the first set of input samples, the second set of output samples p′_{0,1}, p′_{1,1}, p′_{2,1}, p′_{3,1}, p′_{4,1}, q′_{0,1}, q′_{1,1}, q′_{2,1}, q′_{3,1}, q′_{4,1}, are derived from the second set of input samples, the third set of output samples p′_{0,2}, p′_{1,2}, p′_{2,2}, p′_{3,2}, p′_{4,2}, q′_{0,2}, q′_{1,2}, q′_{2,2}, q′_{3,2}, q′_{4,2}, are derived from the third set of input samples, and the fourth set of output samples, p′_{0,3}, p′_{1,3}, p′_{2,3}, p′_{3,3}, p′_{4,3}, q′_{0,3}, q′_{1,3}, q′_{2,3}, q′_{3,3}, q′_{4,3} are derived from the fourth set of input samples.

A8. The method of any one of embodiments A1-A7, wherein the first set of inputs are from a first line across the block boundary including samples p_{0,0}, p_{1,0}, p_{2,0}, p_{3,0}, p_{4,0}, p_{5,0}, p_{6,0}, p_{7,0} on one side of the boundary and q_{0,0}, q_{1,0}, q_{2,0}, q_{3,0} on the other side of the boundary, the second set of inputs are from a second line across the block boundary including samples p_{0,1}, p_{1,1}, p_{2,1}, p_{3,1}, p_{4,1}, p_{5,1}, p_{6,1}, p_{7,1} and q_{0,1}, q_{1,1}, q_{2,1}, q_{3,1} on the other side of the boundary, the third set of inputs are from a third line across the block boundary including samples p_{0,2}, p_{1,2}, p_{2,2}, p_{3,2}, p_{4,2}, p_{5,2}, p_{6,2}, p_{7,2} and q_{0,2}, q_{1,2}, q_{2,2}, q_{3,2} on the other side of the boundary, and the fourth set of inputs are from a fourth line across the block boundary including samples p_{0,3}, p_{1,3}, p_{2,3}, p_{3,3}, p_{4,3}, p_{5,3}, p_{6,3}, p_{7,3} and q_{0,3}, q_{1,3}, q_{2,3}, q_{3,3} on the other side of the boundary, the first set of output samples p′_{0,0}, p′_{1,0}, p′_{2,0}, p′_{3,0}, p′_{4,0}, p′_{5,0}, p′_{6,0}, q′_{0,0}, q′_{1,0}, q′_{2,0}, are derived from the first set of input samples, the second set of output samples p′_{0,1}, p′_{1,1}, p′_{2,1}, p′_{3,1}, p′_{4,1}, p′_{5,1}, p′_{6,1}, q′_{0,2}, q′_{1,2}, q′_{2,2} are derived from the second set of input samples, the third set of output samples p′_{0,2}, p′_{1,2}, p′_{2,2}, p′_{3,2}, p′_{4,2}, p′_{5,2}, p′_{6,2}, q′_{0,2}, q′_{1,2}, q′_{2,2}, are derived from the third set of input samples, and the fourth set of output samples, p′_{0,3}, p′_{1,3}, p′_{2,3}, p′_{3,3}, p′_{4,3}, p′_{5,3}, p′_{6,3}, q′_{0,3}, q′_{1,3}, q′_{2,3} are derived from the fourth set of input samples.

A9. The method of any one of embodiments A1-A8, wherein the first set of inputs are from a first line across the block boundary including samples p_{0,0}, p_{1,0}, p_{2,0}, p_{3,0}, p_{4,0}, p_{5,0} on one side of the boundary and q_{0,0}, q_{1,0}, q_{2,0}, q_{3,0} on the other side of the boundary, the second set of inputs are from a second line across the block boundary including samples p_{0,1}, p_{1,1}, p_{2,1}, p_{3,1}, p_{4,1}, p_{5,1} and q_{0,1}, q_{1,1}, q_{2,1}, q_{3,1} on the other side of the boundary, the third set of inputs are from a third line across the block boundary including samples p_{0,2}, p_{1,2}, p_{2,2}, p_{3,2}, p_{4,2}, p_{5,2} and q_{0,2}, q_{1,2}, q_{2,2}, q_{3,2} on the other side of the boundary, and the fourth set of inputs are from a fourth line across the block boundary including samples p_{0,3}, p_{1,3}, p_{2,3}, p_{3,3}, p_{4,3}, p_{5,3} and q_{0,3}, q_{1,3}, q_{2,3}, q_{3,3} on the other side of the boundary, the first set of output samples p′_{0,0}, p′_{1,0}, p′_{2,0}, p′_{3,0}, p′_{4,0}, q′_{0,1}, q′_{1,1}, q′_{2,1}, are derived from the first set of input samples, the second set of output samples p′_{0,1}, p′_{1,1}, p′_{2,1}, p′_{3,1}, p′_{4,1}, q′_{0,2}, q′_{1,2}, q′_{2,2} are derived from the second set of input samples, the third set of output samples p′_{0,2}, p′_{1,2}, p′_{2,2}, p′_{3,2}, p′_{4,2}, q′_{0,2}, q′_{1,2}, q′_{2,2}, are derived from the third set of input samples, and the fourth set of output samples, p′_{0,3}, p′_{1,3}, p′_{2,3}, p′_{3,3}, p′_{4,3}, q′_{0,3}, q′_{1,3}, q′_{2,3} are derived from the fourth set of input samples.

A10. The method of any one of embodiments A1-A9, wherein the first set of inputs are from a first line across the block boundary including samples p_{0,0}, p_{1,0}, p_{2,0}, p_{3,0} on one side of the boundary and q_{0,0}, q_{1,0}, q_{2,0}, q_{3,0} on the other side of the boundary, the second set of inputs are from a second line across the block boundary including samples p_{0,1}, p_{1,1}, p_{2,1}, p_{3,1} and q_{0,1}, q_{1,1}, q_{2,1}, q_{3,1} on the other side of the boundary, the third set of inputs are from a third line across the block boundary including samples p_{0,2}, p_{1,2}, p_{2,2}, p_{3,2} and q_{0,2}, q_{1,2}, q_{2,2}, q_{3,2} on the other side of the boundary, the fourth set of inputs are from a fourth line across the block boundary including samples p_{0,3}, p_{1,3}, p_{2,3}, p_{3,3} and q_{0,3}, q_{1,3}, q_{2,3}, q_{3,3} on the other side of the boundary, the first set of output samples p′_{0,0}, p′_{1,0}, p′_{2,0}, q′_{0,0}, q′_{1,0}, q′_{2,0} are derived from the first set of input samples, the second set of output samples p′_{0,1}, p′_{1,1}, p′_{2,1}, q′_{0,1}, q′_{1,1}, q′_{2,1}, are derived from the second set of input samples, the third set of output samples p′_{0,2}, p′_{1,2}, p′_{2,2}, q′_{0,2}, q′_{1,2}, q′_{2,2}, are derived from the third set of input samples, and the fourth set of output samples, p′_{0,3}, p′_{1,3}, p′_{2,3}, q′_{0,3}, q′_{1,3}, q′_{2,3} are derived from the fourth set of input samples.

A11. The method of any of the embodiments A1-A10, wherein the block edge decision process for each input set, k, of samples is based on an edge metrics Abs(p_{2,k}−2*p_{1,k}+p_{0,k}), Abs(q_{2,k}−2*q_{1,k}+q_{0,k}), Abs(p_{3,k}−p_{0,k}), Abs(q_{3,k}−q_{0,k}), Abs(p_{0,k}−q_{0,k}).

A12. The method of A11, wherein the block edge decision process for each input set, k, of samples is based on at least one of the edge metrics Abs(p_{5, k}−2*p_{4,k}+p_{3,k}), Abs(p_{3,k}−p_{5,k}) or Abs(q_{5,k}−2*q_{4,k}+q_{3,k}), Abs(q_{3,k}−q_{5,k}).

A13. The method of any of the embodiments A12, wherein the block edge decision process for each input set, k, of samples is based on at least one of the edge metrics Abs(p_{4,k}−p_{5,k}−p_{6,k}+p_{7,k}), Abs(p_{3,k}−p_{7,k}) or Abs(q_{4,k}−q_{5,k}−q_{6,k}+q_{7,k}) Abs(q_{3,k}−q_{7,k}).

B1. A computer program 543 comprising instructions 544 which when executed by processing circuitry 502 causes the processing circuitry 502 to perform the method of any one of the above embodiments.

B2. A carrier containing the computer program of embodiment B1, wherein the carrier is one of an electronic signal, an optical signal, a radio signal, and a computer readable storage medium 542.

C1. An apparatus 501, the apparatus being adapted to perform the method of any one of embodiments A1-A13.

D1. An apparatus 501, the apparatus comprising: processing circuitry 502; and a memory 542, said memory containing instructions 544 executable by said processing circuitry, whereby said apparatus is operative to perform the method of any one of the embodiments A1-A13.

Complexity Analysis

Long deblocking filter can be used when at least one side has a width for vertical boundaries or height for horizontal boundaries of 32 samples or more and the other side has width for vertical boundaries or height for horizontal boundaries of 8 samples or more.

The current long filter decision for that case has for each 4 samples boundary segment to make calculations used for both long and strong deblocking filter but also calculations specific for long filter decision and then also calculations specific for strong filter decision in case long filter not is selected. In total about 2 segments*(28+46+14)/(32*8)=2*88/(32*8)=176/(32*8)=0.69 operations per sample.

The additional complexity for line 1 and 2 are 2 segments*(28+46−2)/(32*8)=2*72=144/(32*8)=0.56 operations per sample.

The total number of operations after the suggested fix is 0.69+0.56=1.25 operations per sample.

The worst case for decision calculations is not modified since that happens when all blocks are 8×8 where the number of operations per sample for decisions are about 2 segments*(28+14)/(8*8)=2*42/64=1.28 operations per sample.

Calculations in general for both long and strong deblocking filter (10 abs+4 shifts+14 adds=28 op):

| | |
|---|---|
| dp0 = Abs(p_{2, 0} − 2 * p_{1, 0} + p_{0, 0}) | (1298) |
| dp3 = Abs(p_{2, 3} − 2 * p_{1, 3} + p_{0, 3}) | (1299) |
| dq0 = Abs(q_{2, 0} − 2 * q_{1, 0} + q_{0, 0}) | (1300) |
| dq3 = Abs(q_{2, 3} − 2 * q_{1, 3} + q_{0, 3}) | (1301) |
| sp0 = Abs(p_{3, 0} − p_{0, 0}) | (1302) |
| sq0 = Abs(q_{0, 0} − q_{3, 0}) | (1303) |
| spq0 = Abs(p_{0, 0} − q_{0, 0}) | (1304) |
| sp3 = Abs(p_{3, 3} − p_{0, 3}) | (1305) |
| sq3 = Abs(q_{0, 3} − q_{3, 3}) | (1306) |
| spq3 = Abs(p_{0, 3} − q_{0, 3}) | (1307) |

Additional calculations for long filter of one side (6 abs+6 shifts+27 adds+7 cmp=46 op):

| | |
|---|---|
| dp0L = (dp0 + Abs(p_{5, 0} − 2 * p_{4, 0} + p_{3, 0}) + 1) >> 1 | (1308) |
| dp3L = (dp3 + Abs(p_{5, 3} − 2 * p_{4, 3} + p_{3, 3}) + 1 ) >> 1 | (1309) |
| sp0L = sp0 + Abs(p_{7, 0} − p_{6, 0} − p_{5, 0} + p_{4, 0}) | (1317) |
| sp3L = sp3 + Abs(p_{7, 3} − p_{6, 3} − p_{5, 3} + p_{4, 3}) | (1318) |
| When dL is less than β | |
| dpq0L = dp0L + dq0L | (1325) |
| dpq3L = dp3L + dq3L | (1326) |
| dL = dpq0L + dpq3L | (1327) |
| 2x: | |
| sp = (sp + Abs(p₃ − p₀) + 1) >> 1 | (1386) |
| dpq is less than (β >> 2), | |
| sp + sq is less than sThr, | |
| spq is less than (5 * t_{C} + 1) >> 1. | |

Additional calculations for strong filter (7 adds+7 cmp=14op):

| | |
|---|---|
| dpq0 = dp0 + dq0 | (1296) |
| dpq3 = dp3 + dq3 | (1297) |
| dp = dp0 + dp3 | (1298) |
| dq = dq0 + dq3 | (1299) |
| d = dpq0 + dpq3 | (1300) |
| When d is less than β | |
| 2x: | |
| dpq is less than (β >> 2), | |
| sp + sq is less than sThr, | |
| spq is less than (5 * t_{C} + 1) >> 1. | |

Results

The objective performance for the proposal is shown below in comparison to VTM-8.0 using CTC. The objective results show a small gain. Encoding time is measured on simulations run on a cluster with machines with same capability but are not reliable. Decoding time is measured by running test and anchor on same machine without yuv output. Encoding and decoding time is similar as for the anchor.

| | All intra | | | | |
|---|---|---|---|---|---|
| | Over VTM-8.0 | | | | |
| | Y | U | V | EncT | DecT |
| Class A1 | −0.01% | 0.01% | 0.00% | 98% | 99% |
| Class A2 | 0.00% | −0.01% | 0.00% | 101% | 99% |
| Class B | 0.00% | 0.00% | 0.01% | 97% | 99% |
| Class C | 0.00% | 0.00% | 0.00% | 91% | 100% |
| Class E | 0.00% | 0.00% | 0.00% | 90% | 98% |
| Overall | 0.00% | 0.00% | 0.00% | 95% | 99% |
| Class D | 0.00% | 0.01% | 0.00% | 87% | 101% |
| Class F | 0.00% | 0.00% | −0.01% | 96% | 100% |

Random access
Over VTM-8.0

| | Y | U | V | EncT | DecT |
|---|---|---|---|---|---|
| Class A1 | −0.03% | −0.03% | −0.01% | 99% | 100% |
| Class A2 | −0.02% | −0.01% | 0.06% | 100% | 100% |
| Class B | 0.01% | −0.07% | 0.02% | 96% | 100% |
| Class C | −0.02% | 0.03% | −0.07% | 92% | 100% |
| Class E | | | | | |
| Overall | −0.01% | −0.02% | 0.00% | 96% | 100% |
| Class D | 0.03% | 0.03% | −0.11% | 91% | 102% |
| Class F | 0.05% | 0.01% | 0.00% | 93% | 99% |

Low-delay B
Over VTM-8.0

| | | | | | |
|---|---|---|---|---|---|
| Class A1 | | | | | |
| Class A2 | | | | | |
| Class B | −0.02% | 0.22% | −0.09% | 102% | 99% |
| Class C | −0.04% | −0.15% | 0.03% | 98% | 102% |
| Class E | −0.12% | −0.23% | −0.26% | 98% | 99% |
| Overall | −0.05% | −0.02% | −0.09% | 100% | 100% |
| Class D | −0.10% | −0.09% | 0.30% | 90% | 97% |
| Class F | −0.01% | 0.75% | 0.22% | 95% | 102% |

| | Low-delay P | | | | |
|---|---|---|---|---|---|
| | Over VTM-8.0 | | | | |
| Class A1 | | | | | |
| Class A2 | | | | | |
| Class B | −0.01% | 0.14% | 0.18% | 99% | 99% |
| Class C | −0.02% | −0.11% | −0.22% | 90% | 101% |
| Class E | −0.02% | −0.37% | 0.20% | 90% | 96% |
| Overall | −0.01% | −0.07% | 0.05% | 94% | 99% |
| Class D | −0.03% | 0.30% | −0.11% | 85% | 104% |
| Class F | −0.08% | −0.13% | −0.30% | 90% | 101% |

### CONCLUSIONS

It is proposed to fix the long luma deblocking decision such that not only lines 0 and 3 are checked but also lines 1 and 2 are checked before application of long luma deblocking filtering. It is proposed to include the fix to the specification and software to reduce the risk of over filtering of luma samples of lines 1 and 2 which can be achieved without increasing worst case complexity for deblocking decisions.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] Joint Video Experts Team (JVET), Versatile Video Coding (Draft 8), WET-Q2001-vE (January 2020).

1. A method for filtering luma block edges, the method comprising:
assigning a value to a first decision variable by performing a block edge decision process using a first set of input samples;
assigning a value to a second decision variable by performing the block edge decision process using a second set of input samples;
assigning a value to a third decision variable by performing the block edge decision process using a third set of input samples;
assigning a value to a fourth decision variable by performing the block edge decision process using a fourth set of input samples;
determining that a long filter condition is satisfied; and
as a result of determining that the long filter condition is satisfied, performing a filtering process for the first set of input samples, the second set of input samples, the third set of input samples and the fourth set of input samples, using a long filter to produce a first set of output samples, a second set of output samples, a third set of output samples and a fourth set of output samples, wherein the long filter condition is satisfied if and only if:
the value of the first decision variable is equal to a first value,
the value of the second decision variable is equal to the first value,
the value of the third decision variable is equal to the first value, and
the value of the fourth decision variable is equal to the first value.

2. The method of claim 1, wherein determining that a long filter condition is satisfied consists of determining that the value of a fifth decision variable is equal to 3.

3. The method of claim 2, further comprising setting the value of the fifth decision variable to 3 as a result of determining that: i) the value of the first decision variable is equal to the first value, ii) the value of the second decision variable is equal to the first value, iii) the value of the third decision variable is equal to the first value, and iv) the value of the fourth decision variable is equal to the first value.

4. The method of claim 1, wherein
the first set of inputs are from a first line across a block boundary including samples p0,0, p1,0, p2,0, p3,0, p4,0, p5,0, p6,0, p7,0 on one side of the boundary and q0,0, q1,0, q2,0, q3,0, q4,0, q5,0, q6,0, q7,0 on the other side of the boundary,
the second set of inputs are from a second line across the block boundary including samples p0,1, p1,1, p2,1, p3,1, p4,1, p5,1, p6,1, p7,1 and q0,1, q1,1, q2,1, q3,1, q4,1, q5,1, q6,1, q7,1 on the other side of the boundary,
the third set of inputs are from a third line across the block boundary including samples p0,2, p1,2, p2,2, p3,2, p4,2, p5,2, p6,2, p7,2 and q0,2, q1,2, q2,2, q3,2, q4,2, q5,2, q6,2, q7,2 on the other side of the boundary, and
the fourth set of inputs are from a fourth line across the block boundary including samples p0,3, p1,3, p2,3, p3,3, p4,3, p5,3, p6,3, p7,3 and q0,3, q1,3, q2,3, q3,3, q4,3, q5,3, q6,3, q7,3 on the other side of the boundary.

5. The method of claim 1, wherein
the first set of output samples p′0,0, p′1,0, p′2,0, p′3,0, p′4,0, p′5,0, p′6,0, q′0,0, q′1,0, q′2,0, q′3,0, q′4,0, q′5,0, q′6,0, are derived from the first set of input samples,
the second set of output samples p′0,1, p′1,1, p′2,1, p′3,1, p′4,1, p′5,1, p′6,1, q′0,1, q′1,1, q′2,1, q′3,1, q′4,1, q′5,1, q′6,1, are derived from the second set of input samples,
the third set of output samples p′0,2, p′1,2, p′2,2, p′3,2, p′4,2, p′5,2, p′6,2, q′0,2, q′1,2, q′2,2, q′3,2, q′4,2, q′5,2, q′6,2, are derived from the third set of input samples, and
the fourth set of output samples, p′0,3, p′1,3, p′2,3, p′3,3, p′4,3, p′5,3, p′6,3, q′0,3, q′1,3, q′2,3, q′3,3, q′4,3, q′5,3, q′6,3 are derived from the fourth set of input samples.

6. The method of claim 1, wherein
the first set of inputs are from a first line across the block boundary including samples p0,0, p1,0, p2,0, p3,0, p4,0, p5,0 on one side of the boundary and q0,0, q1,0, q2,0, q3,0, q4,0, q5,0 on the other side of the boundary,
the second set of inputs are from a second line across the block boundary including samples p0,1, p1,1, p2,1, p3,1, p4,1, p5,1 and q0,1, q1,1, q2,1, q3,1, q4,1, q5,1 on the other side of the boundary,
the third set of inputs are from a third line across the block boundary including samples p0,2, p1,2, p2,2, p3,2, p4,2, p5,2 and q0,2, q1,2, q2,2, q3,2, q4,2, q5,2 on the other side of the boundary, and
the fourth set of inputs are from a fourth line across the block boundary including samples p0,3, p1,3, p2,3, p3,3, p4,3, p5,3 and q0,3, q1,3, q2,3, q3,3, q4,3, q5,3 on the other side of the boundary,
the first set of output samples p′0,0, p′1,0, p′2,0, p′3,0, p′4,0, q′0,0, q′ 1,0, q′2,0, q′3,0, q′4,0, are derived from the first set of input samples,
the second set of output samples p′0,1, p′1,1, p′2,1, p′3,1, p′4,1, q′0,1, q′1,1, q′2,1, q′3,1, q′4,1, are derived from the second set of input samples,
the third set of output samples p′0,2, p′1,2, p′2,2, p′3,2, p′4,2, q′0,2, q′1,2, q′2,2, q′3,2, q′4,2, are derived from the third set of input samples, and
the fourth set of output samples, p′0,3, p′1,3, p′2,3, p′3,3, p′4,3, q′0,3, q′ 1,3, q′2,3, q′3,3, q′4,3 are derived from the fourth set of input samples.

7. The method of claim 1, wherein
the first set of inputs are from a first line across the block boundary including samples p0,0, p1,0, p2,0, p3,0, p4,0, p5,0, p6,0, p7,0 on one side of the boundary and q0,0, q1,0, q2,0, q3,0 on the other side of the boundary,
the second set of inputs are from a second line across the block boundary including samples p0,1, p1,1, p2,1, p3,1, p4,1, p5,1, p6,1, p7,1 and q0,1, q1,1, q2,1, q3,1 on the other side of the boundary,
the third set of inputs are from a third line across the block boundary including samples p0,2, p1,2, p2,2, p3,2, p4,2, p5,2, p6,2, p7,2 and q0,2, q1,2, q2,2, q3,2 on the other side of the boundary, and
the fourth set of inputs are from a fourth line across the block boundary including samples p0,3, p1,3, p2,3, p3,3, p4,3, p5,3, p6,3, p7,3 and q0,3, q1,3, q2,3, q3,3 on the other side of the boundary,
the first set of output samples p′0,0, p′1,0, p′2,0, p′3,0, p′4,0, p′5,0, p′6,0, q′0,0, q′1,0, q′2,0, are derived from the first set of input samples,
the second set of output samples p′0,1, p′1,1, p′2,1, p′3,1, p′4,1, p′5,1, p′6,1, q′0,2, q′1,2, q′2,2 are derived from the second set of input samples,
the third set of output samples p′0,2, p′1,2, p′2,2, p′3,2, p′4,2, p′5,2, p′6,2, q′0,2, q′1,2, q′2,2, are derived from the third set of input samples, and
the fourth set of output samples, p′0,3, p′1,3, p′2,3, p′3,3, p′4,3, p′5,3, p′6,3, q′0,3, q′1,3, q′2,3 are derived from the fourth set of input samples.

8. The method of claim 1, wherein
the first set of inputs are from a first line across the block boundary including samples p0,0, p1,0, p2,0, p3,0, p4,0, p5,0 on one side of the boundary and q0,0, q1,0, q2,0, q3,0 on the other side of the boundary,
the second set of inputs are from a second line across the block boundary including samples p0,1, p1,1, p2,1, p3,1, p4,1, p5,1 and q0,1, q1,1, q2,1, q3,1 on the other side of the boundary,
the third set of inputs are from a third line across the block boundary including samples p0,2, p1,2, p2,2, p3,2, p4,2, p5,2 and q0,2, q1,2, q2,2, q3,2 on the other side of the boundary, and
the fourth set of inputs are from a fourth line across the block boundary including samples p0,3, p1,3, p2,3, p3,3, p4,3, p5,3 and q0,3, q1,3, q2,3, q3,3 on the other side of the boundary,
the first set of output samples p′0,0, p′1,0, p′2,0, p′3,0, p′4,0, q′0,1, q′1,1, q′2,1, are derived from the first set of input samples,
the second set of output samples p′0,1, p′1,1, p′2,1, p′3,1, p′4,1, q′0,2, q′1,2, q′2,2 are derived from the second set of input samples,
the third set of output samples p′0,2, p′1,2, p′2,2, p′3,2, p′4,2, q′0,2, q′1,2, q′2,2, are derived from the third set of input samples, and
the fourth set of output samples, p′0,3, p′1,3, p′2,3, p′3,3, p′4,3, q′0,3, q′ 1,3, q′2,3 are derived from the fourth set of input samples.

9. The method of claim 1, wherein
the first set of inputs are from a first line across the block boundary including samples p0,0, p1,0, p2,0, p3,0 on one side of the boundary and q0,0, q1,0, q2,0, q3,0 on the other side of the boundary,
the second set of inputs are from a second line across the block boundary including samples p0,1, p1,1, p2,1, p3,1 and q0,1, q1,1, q2,1, q3,1 on the other side of the boundary,
the third set of inputs are from a third line across the block boundary including samples p0,2, p1,2, p2,2, p3,2 and q0,2, q1,2, q2,2, q3,2 on the other side of the boundary,
the fourth set of inputs are from a fourth line across the block boundary including samples p0,3, p1,3, p2,3, p3,3 and q0,3, q1,3, q2,3, q3,3 on the other side of the boundary,
the first set of output samples p′0,0, p′1,0, p′2,0, q′0,0, q′1,0, q′2,0 are derived from the first set of input samples,
the second set of output samples p′0,1, p′1,1, p′2,1, q′0,1, q′1,1, q′2,1, are derived from the second set of input samples,
the third set of output samples p′0,2, p′1,2, p′2,2, q′0,2, q′1,2, q′2,2, are derived from the third set of input samples, and
the fourth set of output samples, p′0,3, p′1,3, p′2,3, q′0,3, q′1,3, q′2,3 are derived from the fourth set of input samples.

10. The method of claim 1, wherein the block edge decision process for each input set, k, of samples is based on an edge metrics Abs(p2,k−2*p1,k+p0,k), Abs(q2,k−2*q1,k+q0,k), Abs(p3,k−p0,k), Abs(q3,k−q0,k), Abs(p0,k−q0,k).

11. The method of claim 10, wherein the block edge decision process for each input set, k, of samples is based on at least one of the edge metrics Abs(p5,k−2*p4,k+p3,k), Abs(p3,k−p5,k) or Abs(q5,k−2*q4,k+q3,k), Abs(q3,k−q5,k).

12. The method of claim 11, wherein the block edge decision process for each input set, k, of samples is based on at least one of the edge metrics Abs(p4,k−p5,k−p6,k+p7,k), Abs(p3,k−p7,k) or Abs(q4,k−q5,k−q6,k+q7,k), Abs(q3,k−q7,k).

13. A computer program comprising instructions which when executed by processing circuitry of an apparatus causes the apparatus to perform the method claim 1.

14-16. (canceled)

17. An apparatus, the apparatus comprising:
processing circuitry; and
a memory, said memory containing instructions executable by said processing circuitry, wherein the apparatus is configured to perform a process comprising:
assigning a value to a first decision variable by performing a block edge decision process using a first set of input samples;
assigning a value to a second decision variable by performing the block edge decision process using a second set of input samples;
assigning a value to a third decision variable by performing the block edge decision process using a third set of input samples;
assigning a value to a fourth decision variable by performing the block edge decision process using a fourth set of input samples;
determining that a long filter condition is satisfied; and
as a result of determining that the long filter condition is satisfied, performing a filtering process for the first set of input samples, the second set of input samples, the third set of input samples and the fourth set of input samples, using a long filter to produce a first set of output samples, a second set of output samples, a third set of output samples and a fourth set of output samples, wherein the long filter condition is satisfied if and only if:
the value of the first decision variable is equal to a first value,
the value of the second decision variable is equal to the first value,
the value of the third decision variable is equal to the first value, and
the value of the fourth decision variable is equal to the first value.

18. The apparatus of claim 17, wherein determining that a long filter condition is satisfied consists of determining that the value of a fifth decision variable is equal to 3.

19. The apparatus of claim 2, further comprising setting the value of the fifth decision variable to 3 as a result of determining that: i) the value of the first decision variable is equal to the first value, ii) the value of the second decision variable is equal to the first value, iii) the value of the third decision variable is equal to the first value, and iv) the value of the fourth decision variable is equal to the first value.

20. The apparatus of claim 17, wherein
the first set of inputs are from a first line across a block boundary including samples p0,0, p1,0, p2,0, p3,0, p4,0, p5,0, p6,0, p7,0 on one side of the boundary and q0,0, q1,0, q2,0, q3,0, q4,0, q5,0, q6,0, q7,0 on the other side of the boundary,
the second set of inputs are from a second line across the block boundary including samples p0,1, p1,1, p2,1, p3,1, p4,1, p5,1, p6,1, p7,1 and q0,1, q1,1, q2,1, q3,1, q4,1, q5,1, q6,1, q7,1 on the other side of the boundary,
the third set of inputs are from a third line across the block boundary including samples p0,2, p1,2, p2,2, p3,2, p4,2, p5,2, p6,2, p7,2 and q0,2, q1,2, q2,2, q3,2, q4,2, q5,2, q6,2, q7,2 on the other side of the boundary, and
the fourth set of inputs are from a fourth line across the block boundary including samples p0,3, p1,3, p2,3, p3,3, p4,3, p5,3, p6,3, p7,3 and q0,3, q1,3, q2,3, q3,3, q4,3, q5,3, q6,3, q7,3 on the other side of the boundary.

21. The apparatus of claim 17, wherein
the first set of output samples p′0,0, p′1,0, p′2,0, p′3,0, p′4,0, p′5,0, p′6,0, q′0,0, q′1,0, q′2,0, q′3,0, q′4,0, q′5,0, q′6,0, are derived from the first set of input samples,
the second set of output samples p′0,1, p′1,1, p′2,1, p′3,1, p′4,1, p′5,1, p′6,1, q′0,1, q′1,1, q′2,1, q′3,1, q′4,1, q′5,1, q′6,1, are derived from the second set of input samples,
the third set of output samples p′0,2, p′1,2, p′2,2, p′3,2, p′4,2, p′5,2, p′6,2, q′0,2, q′1,2, q′2,2, q′3,2, q′4,2, q′5,2, q′6,2, are derived from the third set of input samples, and
the fourth set of output samples, p′0,3, p′1,3, p′2,3, p′3,3, p′4,3, p′5,3, p′6,3, q′0,3, q′1,3, q′2,3, q′3,3, q′4,3, q′5,3, q′6,3 are derived from the fourth set of input samples.

22. The apparatus of claim 17, wherein
the first set of inputs are from a first line across the block boundary including samples p0,0, p1,0, p2,0, p3,0, p4,0, p5,0 on one side of the boundary and q0,0, q1,0, q2,0, q3,0, q4,0, q5,0 on the other side of the boundary,
the second set of inputs are from a second line across the block boundary including samples p0,1, p1,1, p2,1, p3,1, p4,1, p5,1 and q0,1, q1,1, q2,1, q3,1, q4,1, q5,1 on the other side of the boundary,
the third set of inputs are from a third line across the block boundary including samples p0,2, p1,2, p2,2, p3,2, p4,2, p5,2 and q0,2, q1,2, q2,2, q3,2, q4,2, q5,2 on the other side of the boundary, and
the fourth set of inputs are from a fourth line across the block boundary including samples p0,3, p1,3, p2,3, p3,3, p4,3, p5,3 and q0,3, q1,3, q2,3, q3,3, q4,3, q5,3 on the other side of the boundary,
the first set of output samples p′0,0, p′1,0, p′2,0, p′3,0, p′4,0, q′0,0, q′1,0, q′2,0, q′3,0, q′4,0, are derived from the first set of input samples,
the second set of output samples p′0,1, p′1,1, p′2,1, p′3,1, p′4,1, q′0,1, q′1,1, q′2,1, q′3,1, q′4,1, are derived from the second set of input samples,
the third set of output samples p′0,2, p′1,2, p′2,2, p′3,2, p′4,2, q′0,2, q′1,2, q′2,2, q′3,2, q′4,2, are derived from the third set of input samples, and
the fourth set of output samples, p′0,3, p′1,3, p′2,3, p′3,3, p′4,3, q′0,3, q′1,3, q′2,3, q′3,3, q′4,3 are derived from the fourth set of input samples.

23. The apparatus of claim 17, wherein
the first set of inputs are from a first line across the block boundary including samples p0,0, p1,0, p2,0, p3,0, p4,0, p5,0, p6,0, p7,0 on one side of the boundary and q0,0, q1,0, q2,0, q3,0 on the other side of the boundary,
the second set of inputs are from a second line across the block boundary including samples p0,1, p1,1, p2,1, p3,1, p4,1, p5,1, p6,1, p7,1 and q0,1, q1,1, q2,1, q3,1 on the other side of the boundary,
the third set of inputs are from a third line across the block boundary including samples p0,2, p1,2, p2,2, p3,2, p4,2, p5,2, p6,2, p7,2 and q0,2, q1,2, q2,2, q3,2 on the other side of the boundary, and
the fourth set of inputs are from a fourth line across the block boundary including samples p0,3, p1,3, p2,3, p3,3, p4,3, p5,3, p6,3, p7,3 and q0,3, q1,3, q2,3, q3,3 on the other side of the boundary,
the first set of output samples p′0,0, p′1,0, p′2,0, p′3,0, p′4,0, p′5,0, p′6,0, q′0,0, q′1,0, q′2,0, are derived from the first set of input samples,
the second set of output samples p′0,1, p′1,1, p′2,1, p′3,1, p′4,1, p′5,1, p′6,1, q′0,2, q′1,2, q′2,2 are derived from the second set of input samples,
the third set of output samples p′0,2, p′1,2, p′2,2, p′3,2, p′4,2, p′5,2, p′6,2, q′0,2, q′1,2, q′2,2, are derived from the third set of input samples, and
the fourth set of output samples, p′0,3, p′1,3, p′2,3, p′3,3, p′4,3, p′5,3, p′6,3, q′0,3, q′1,3, q′2,3 are derived from the fourth set of input samples.
